(19) United States
(12) Patent Application Publication
(10) Pub. No.: US 2015/0058083 A1
(43) Pub. Date: Feb. 26, 2015

(54) SYSTEM FOR PERSONALIZED FASHION SERVICES

(71) Applicant: Isabel Herrera, Baltimore, MD (US)

(72) Inventor: Isabel Herrero, Baltimore, MD (US)

(21) Appl. No.: 14/380,138

(22) PCT Filed: Feb. 25, 2013
(86) PCT No.: PCT/US13/27635

§ 371 Date: Aug. 21, 2014

Related U.S. Application Data
(60) Provisional application No. 61/611,208, filed on Mar. 15, 2012.

(51) Int. Cl. G06Q 30/06; G06Q 50/00

(52) U.S. Cl. CPC G06Q 30/0643; G06Q 50/01
USPC 705/7.32; 705/27.2; 705/7.29; 705/14.72

(57) ABSTRACT

A personalized fashion service network system. The system includes a closet module that enables a user to build a virtual closet inventory in accordance to her/his real physical closet inventory, and a virtual fitting room for a user to design personalized fashion styles based on his/her closet inventory. The system also includes a styling platform that allows a user to seek opinions from a professional stylist or a friend about the closet inventory. A swapping engine is included in the system for a user to trade items in the inventory with another user. The system further involves a shopping component, that will able a user to shop with personal guidance.

### CROSS REFERENCE

This application claims the benefit of the U.S. Provisional Patent Application No. 61/611208, filed on Mar. 15, 2012, the entirety of which is hereby incorporated by reference.

### BACKGROUND OF THE INVENTION

1. Field of the Invention

The present invention relates to a fashion service network, more particularly, the present invention provides an electronic network system for personalized fashion services where a user can communicate with fashion friends and fashion stylists for fashion advices, closet item swapping, and follow fashion trends around the world with a click.

2. Description of the Related Art

Internet applications including hardware and software systems have enabled communications and trading among groups and individuals around the world with the easiness of a couple of clicks away. Numerous attempts have been made to move the fashion world into the virtual world, and to make fashion publications more accessible to the public as well.

For example, U.S. Pat. No. 7,328,119 B1 describes a computer system for generating personalized clothing shopping plan for a customer through collecting the customer's video images and creating a dressed model for him/her. US 2009/0018926 A1 and WO 2011/111025 A2 describe a web-based virtual clothing graphic coordinator that takes a customer's personal body information and displays an image of a personalized mannequin with a selected clothing item in saving a customer's shopping and fitting time. US 2011/0218664A1 further describes a computerized modeling system for personalized fashion looks and designs.

Moreover, US 2011/0258069A1 describes a web-based trading system through non-monetary exchanges for trading away unused items including fashion items.

However, all of the described systems are focused on computerization, none of them incorporates a human service. But since the fashion professionals, the stylists, the models and the designers play a big role in shaping and forming fashion trends, there is a need for a computerized network trading and service system that also integrates the professional services and fashion friends into the system, and a service system that can be available for anybody anytime, anywhere, 24 hours of the day, a service system that can be personalized for individual needs of each individual's style, body type and fashion preference.

### ASPECTS AND SUMMARY OF THE INVENTION

This application discloses a novel electronic network system StyleMeWorld for providing personalized fashion services.

In an embodiment, a StyleMeWorld system enables an end user to build a fashion related profile by identifying personal information and favorite fashion styles and fashion persons, and writing fashion journals to record any of the personal fashion moments. The system also enables an end user to build a personalized closet that resembles and represents his/her own real closet for managing her/his fashion needs. When virtual closet is established and propagated with the items from real world closet, a stylist is able to work on the closet items and create looks and place the looks in “my styled looks” section. In one aspect of an embodiment, StyleMeWorld system provides a My-Styled-Looks platform to enable a user to match clothes and other fashion items in the closet and to display a personalized fashion image with selected items from the closet. In another aspect, StyleMeWorld system provides a trading engine and a searching engine that allow a user to mark items in the closet for trade and also to search and shop online to add more items to the closet. When a purchase is made in one of the stores associated with the StyleMeWorld system, the information of that item is added to the user's closet automatically through barcode tracking or item number. Associated style information and suggestions about other items may be suggested to the user in Style Me Recommendations utility.

In an embodiment, a StyleMeWorld system also provides a StyleMe communication platform that enables a user to send a request to seek suggestions from a professional fashion service provider and allow closet access to professional service providers and fashion friends to evaluate the user's collections in the closet and to provide fashion suggestions based on the collections in the closet. A user is able to bid for a famous stylist's opinion through the system, if he/she is lucky enough to be chosen, a personalized video streaming conference may be conducted through the system so that the user feels a personal connection to the professional fashion world and the celebrity world that is used to be inaccessible. In one aspect of an embodiment, a user is allowed access to editorially assembled collections of world fashion publications and editorially assembled World.TV multimedia platform specifically designed for local fashion news and trends and around the world.

In an embodiment, a StyleMeWorld system provides a shopping platform, allowing professional fashion service providers to display their showcases, to build a fashion store in a fashion mall. The guidance of a stylist in shopping fashion items and for special occasions may be requested through the system. In one aspect, a search engine based on index and keyword are provided and coupled with a trade engine to allow a user to shop for any items, and shopped items will automatically be tracked for status and be placed in the user's closet.

In an embodiment, a StyleMeWorld system provides a swapping engine and platform for users to make fashion friends and to communicate with fashion friends and to exchange tradable items in each other's closet. Without spending real money, a user may expand his/her fashion styles through the swapping engine and platform. The swapping engine and platform also serves as a social engine for fashion loving people to know each other and to find friends around the world.

In one aspect, the swap platform also provides a swapping community information exchanges about coming fashion events and tips for laundering and shipping, and a booking service web link for booking event flight etc. Status of a swapping event is also tracked automatically.

The above and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 illustrates the major network components of a StyleMeWorld system in accordance with this application.

FIG. 2A schematically shows major functional modules associated with an end user login in accordance with this application.

FIG. 2B schematically shows major functional modules associated with a service provider login in accordance with this application.

FIG. 2C schematically shows major functional modules associated with a system editor or administrator login in accordance with this application.

FIG. 3A and 3B schematically show major functionalities performed by the functional modules associated with an end user login in accordance with this application.

FIG. 4 schematically shows major databases associated with each of the user types in accordance with this application.

FIG. 5 schematically shows a network of server hierarchies and configurations in accordance with this application.

FIG. 6 schematically shows interactions of end users with fashion professional service providers and fashion stores in accordance with this application.

FIG. 7 schematically shows a data analysis machine for providing market trends in accordance with this application.

FIG. 8 schematically shows a marketing incentive program in accordance with this application.

FIGS. 9-62 show example screenshots of various user interfaces of the major functionalities in accordance with this application.

### DETAILED DESCRIPTION OF THE PREFERRED EMBODIMENTS

Reference will now be made in detail to embodiments of the invention. The drawings are in simplified form and are not to precise scale. And the web graphic designs are examples how the user interface can be implemented, it does not mean that these are the only suitable designs of the user interfaces, many other types of user graphic designs may be implemented to envelope the same ideas described in this application. For purposes of convenience and clarity only, directional (up/down, etc.) or motional (forward/back, etc.) terms may be used with respect to the drawings. These and similar directional terms should not be construed to limit the scope of the invention in any manner.

The invention is a web based electronic and wireless network system with central servers and user login terminals. For clarity reasons, the commonly available electronic and wireless network system software and hardware information are omitted in the description in order to focus on the inventive features. System background information may be found in U.S. Pat. No. 7,065,574 B1, the entirety of which is incorporated by reference herein.

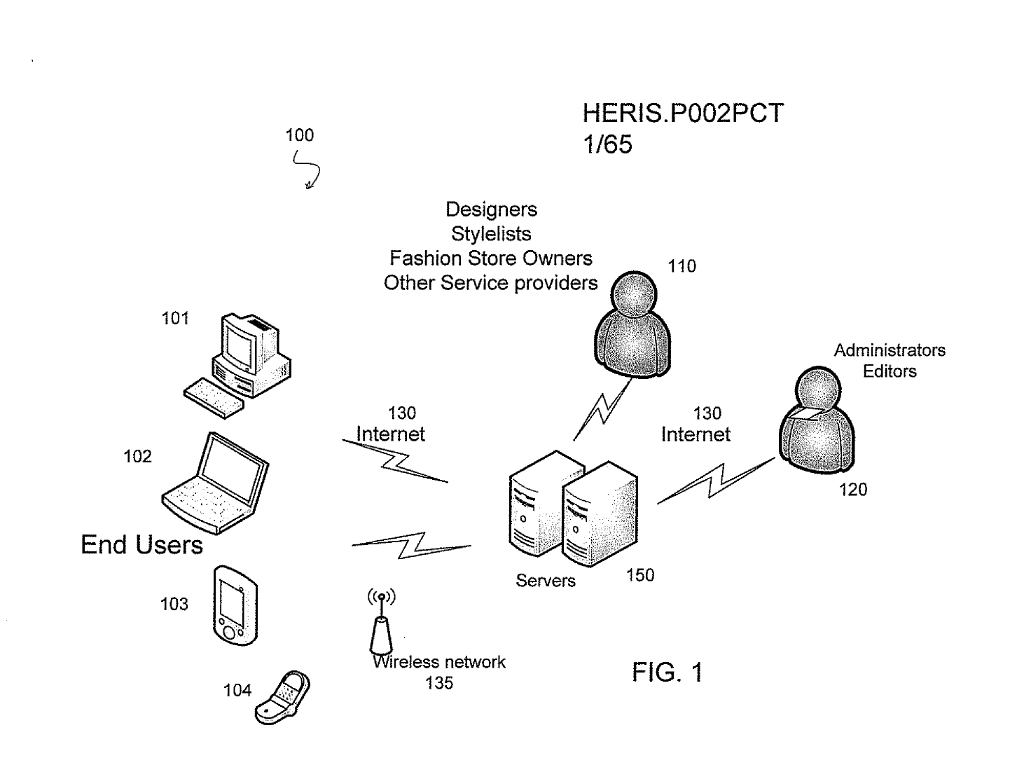

In reference to FIG. 1, a StyleMeWorld network system 100 includes central server system 150, end users accesses the network system 100 through various computing devices, either a computer terminal 101, a laptop 102, a person device such as a iPad 103, or a cell phone 104 by connecting to the internet 130 or the wireless communication network 135. However, by no means the system is limited to these electronic tools. Other electronic devices may be developed as technology develops or as more devices are made available. For example, applications may be imbedded in a game machine, an exercising device, etc. End users may include for example any individual fashion lovers, shopping customers, college students and high schoolers, and any people who like to shop online or online communications. Other types of users are the fashion service providers 110, including for example designers, stylelists, fashion and clothing store owners and fashion commentators and other service providers. User 120 includes StyleMeWorld network system content editors and administrators who generally have management or administrative rights to the system.

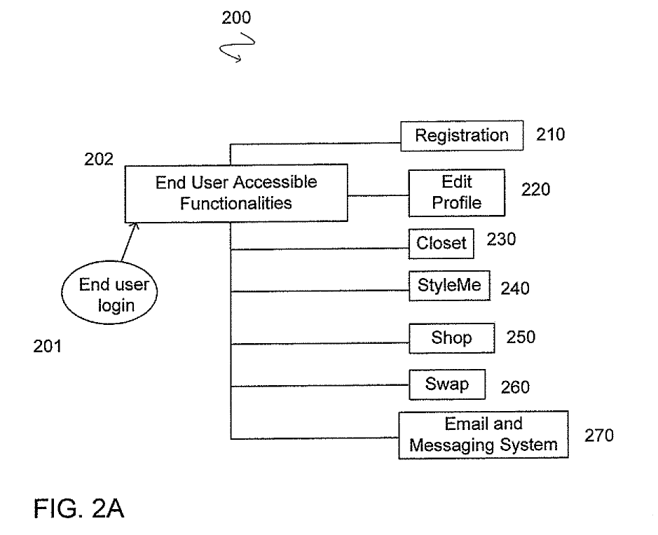

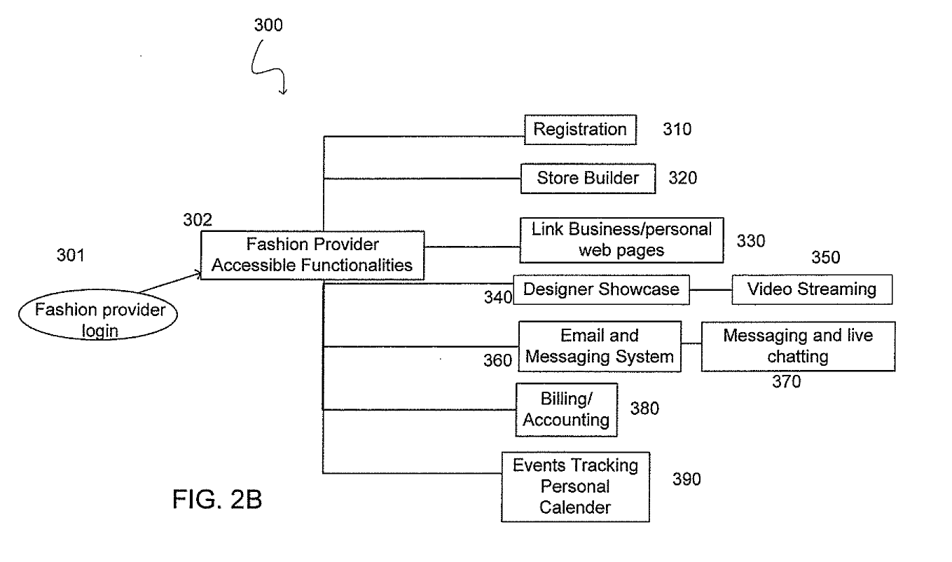

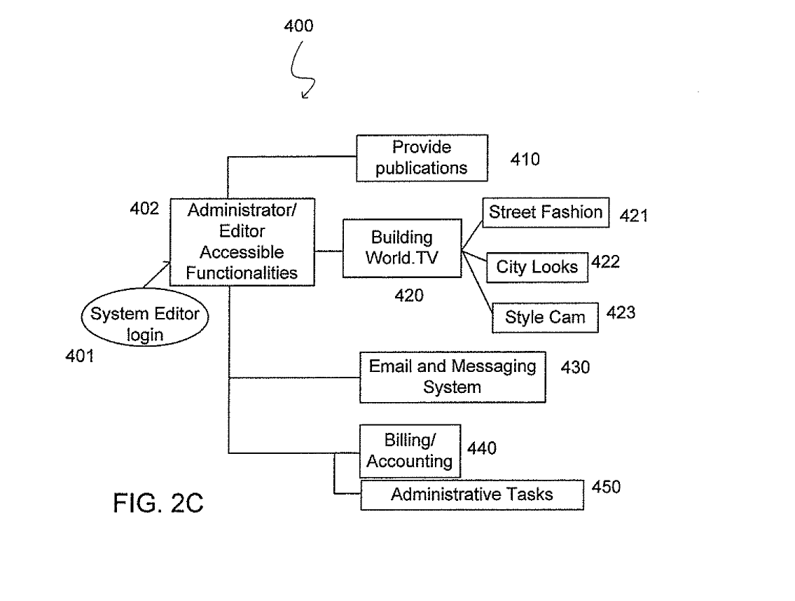

In reference to FIG. 2A, end user body of functional modules 200 includes End User login module 201, End User functionality coordinator/controller 202, end user Registration module 210, Profile builder 220, Closet manager 230, StyleMe manager 240, Shopping Platform 250, Swapping Engine 260 and Email and messaging system 270. The individual modules interact with each other through the functionality controller 202 to access relevant databases and to call other User's functionalities.

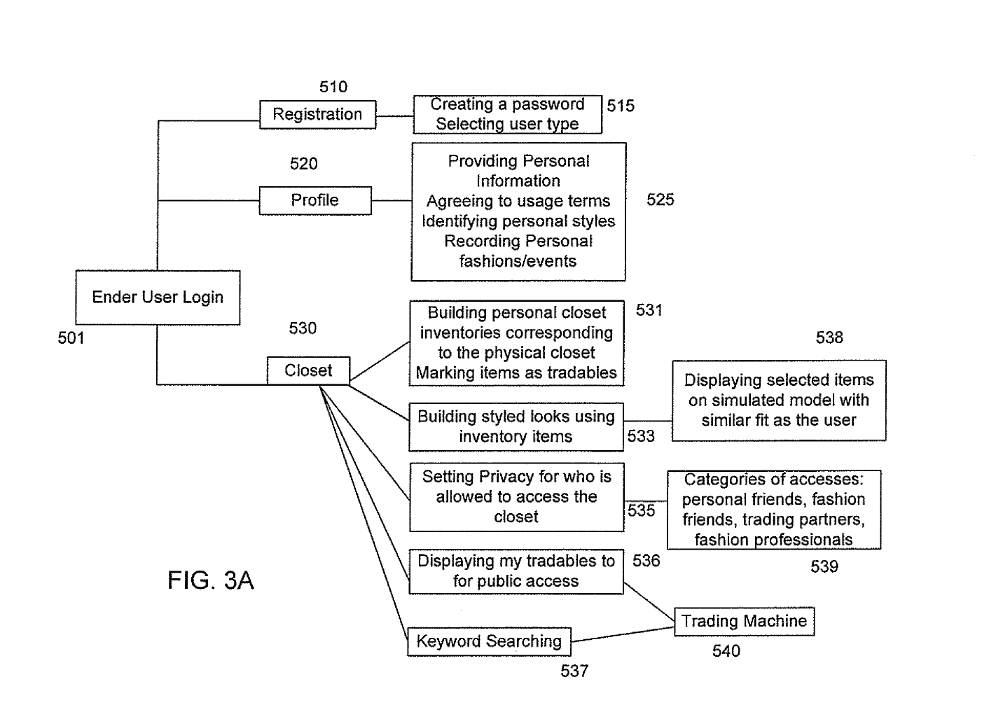

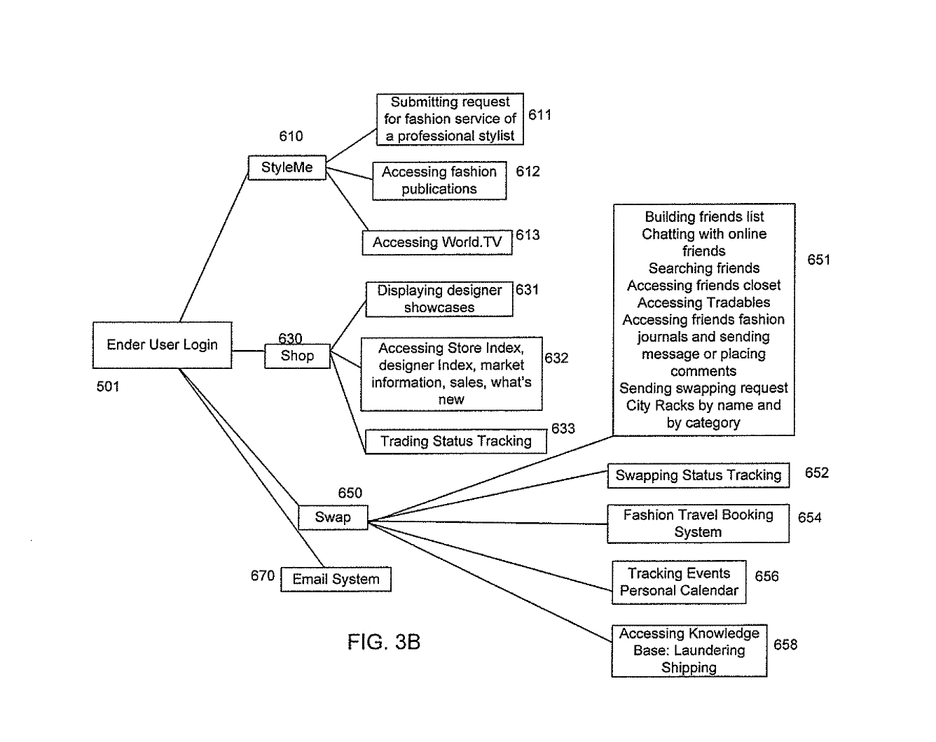

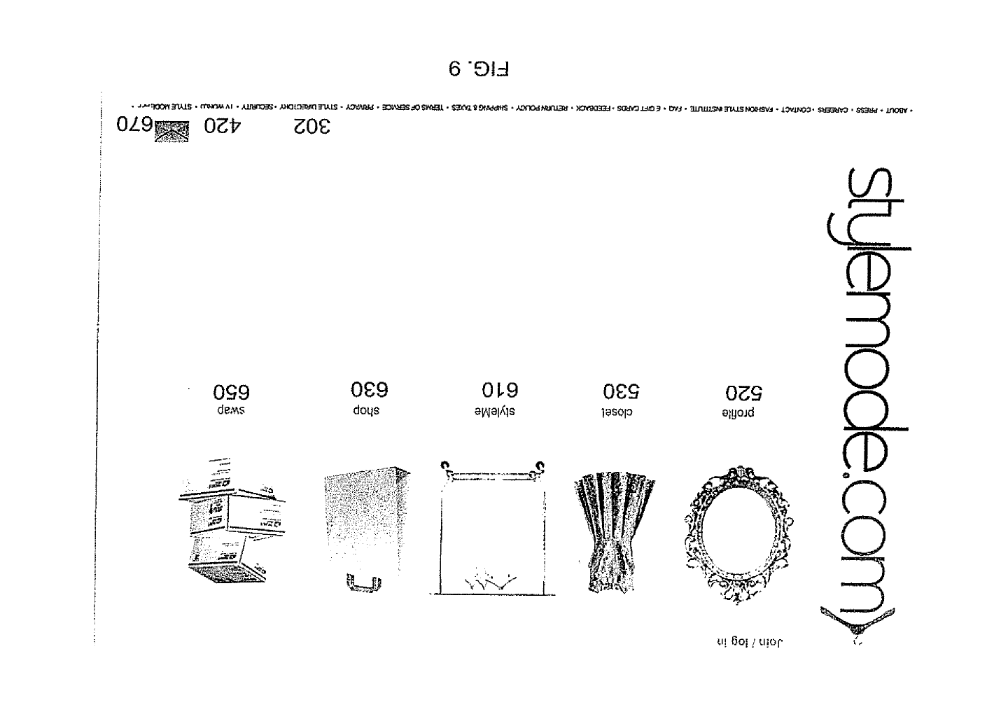

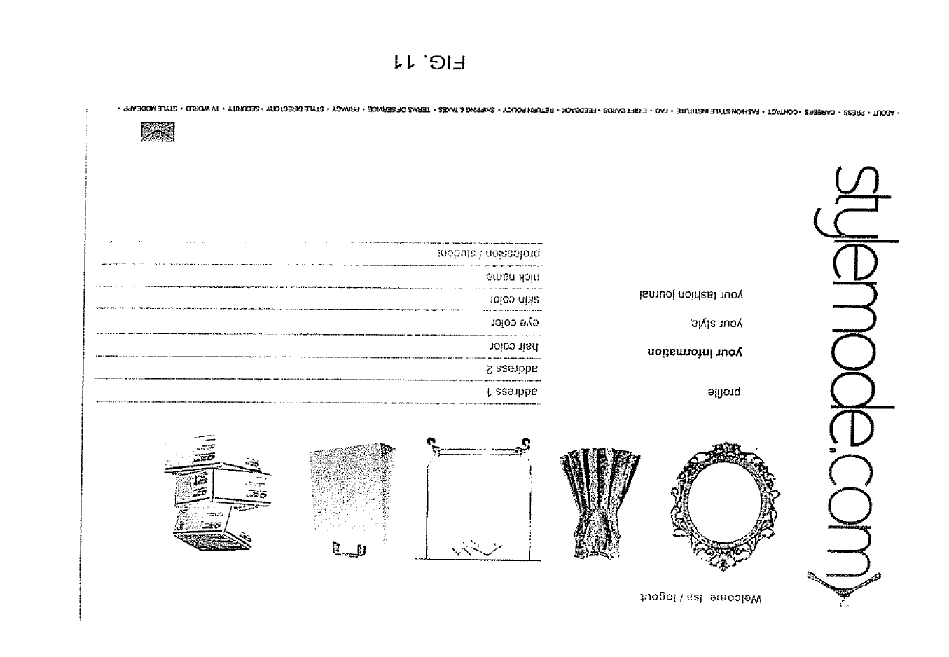

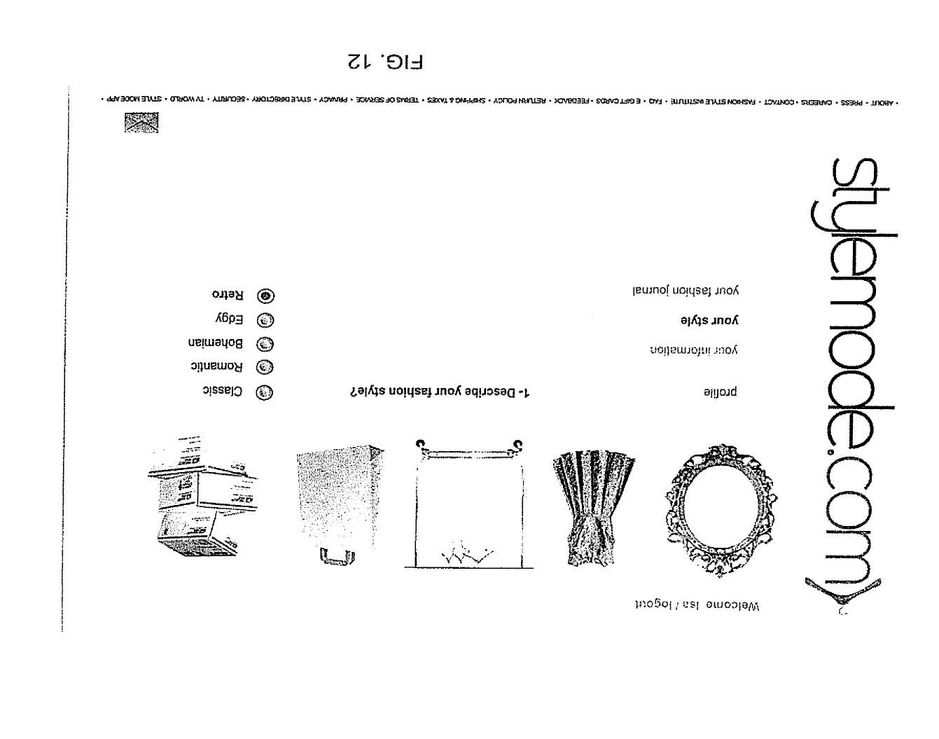

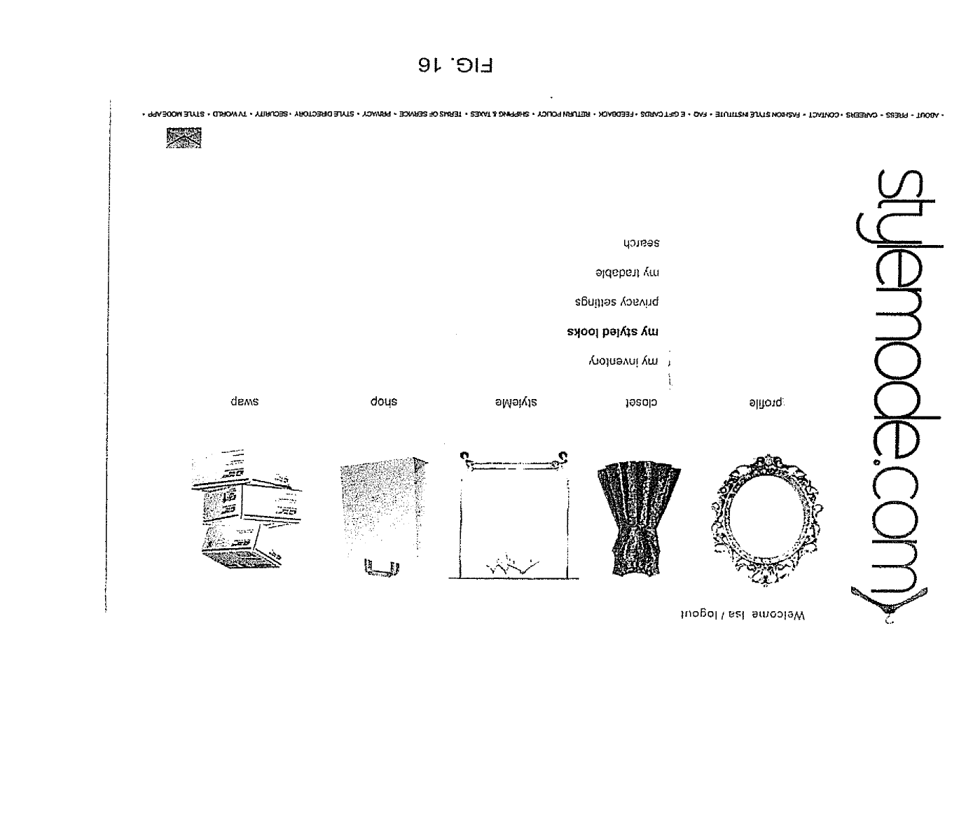

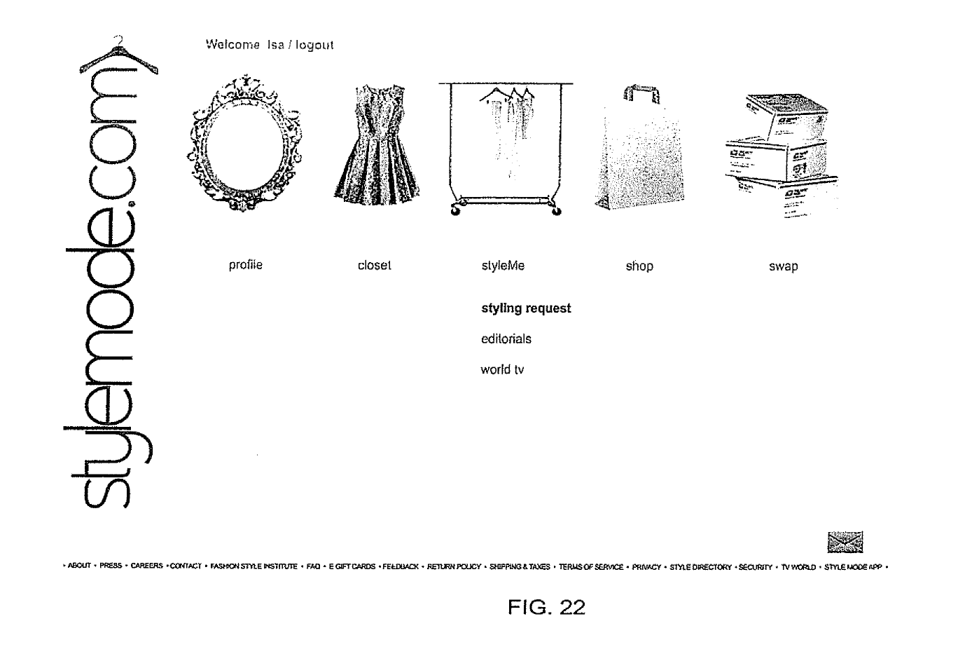

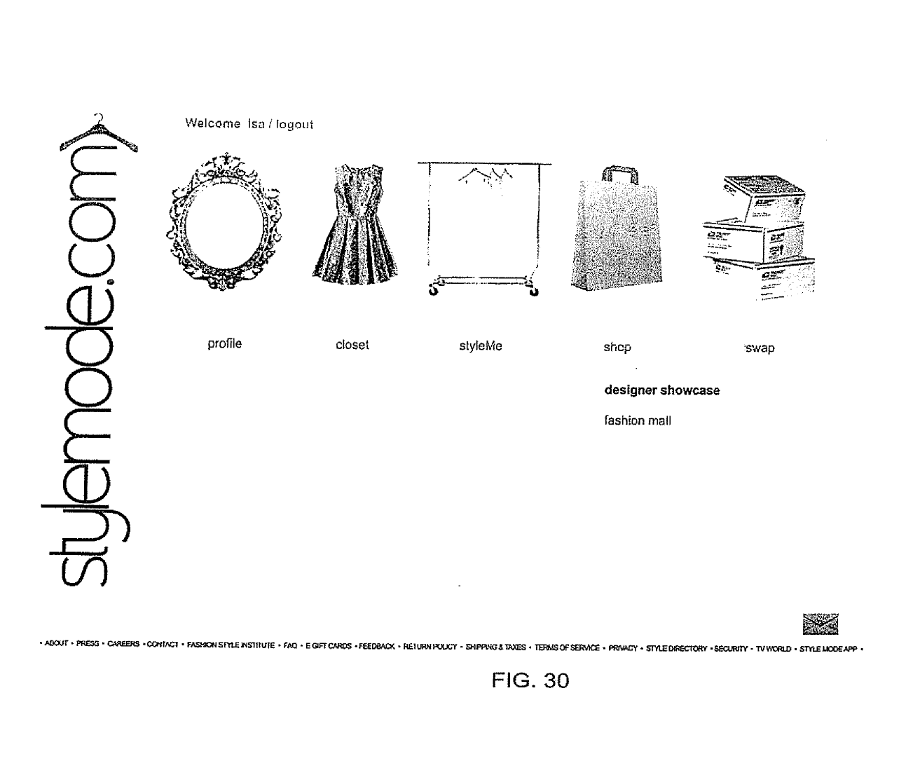

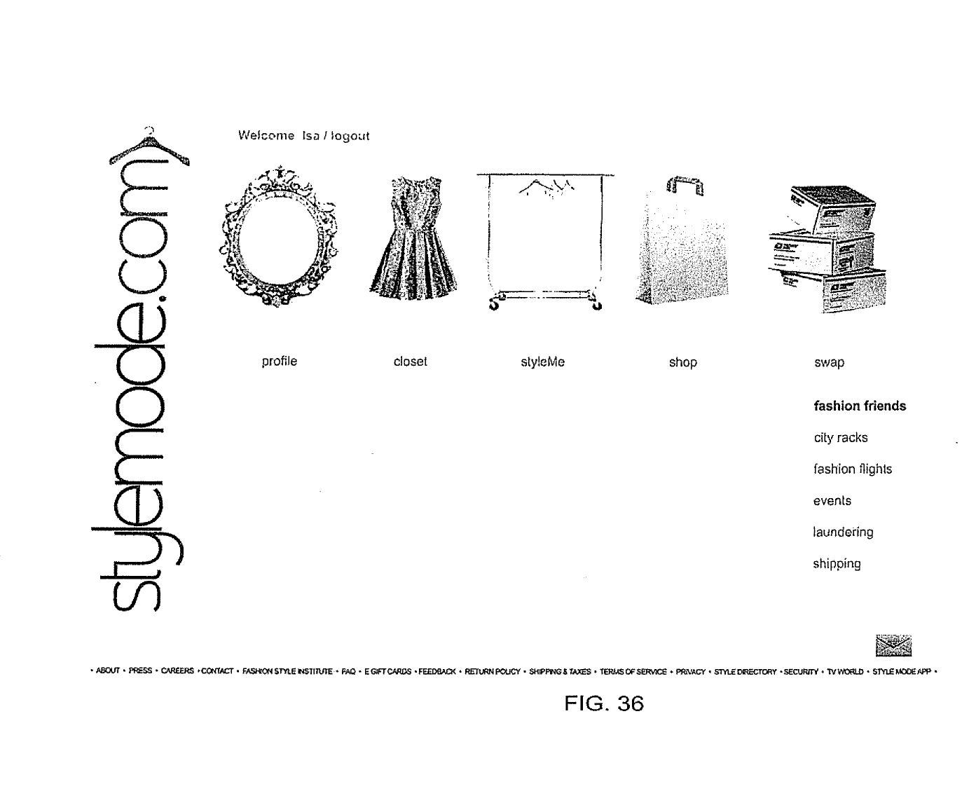

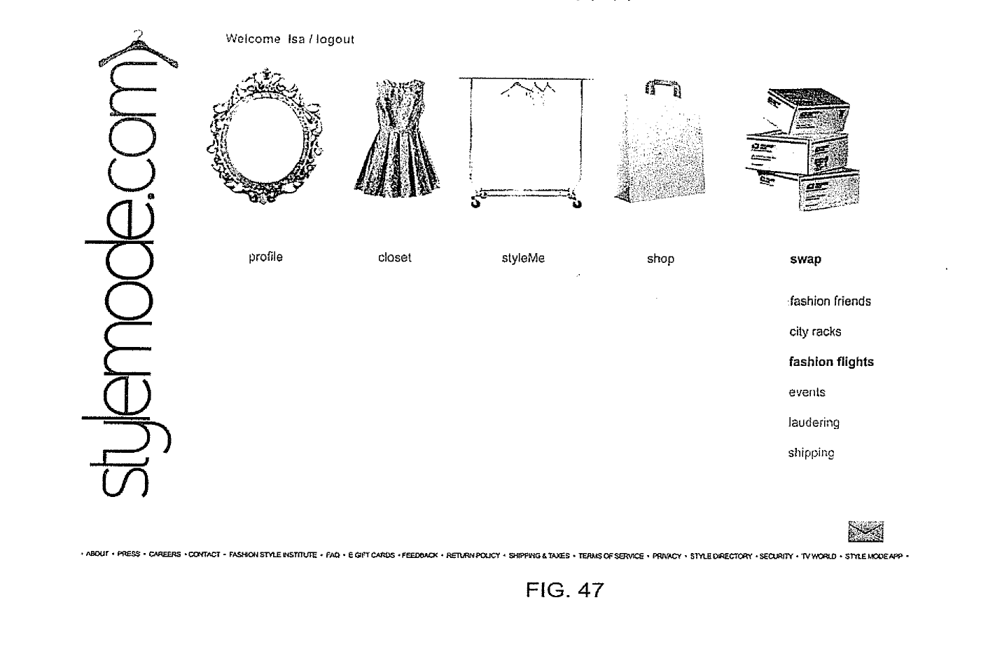

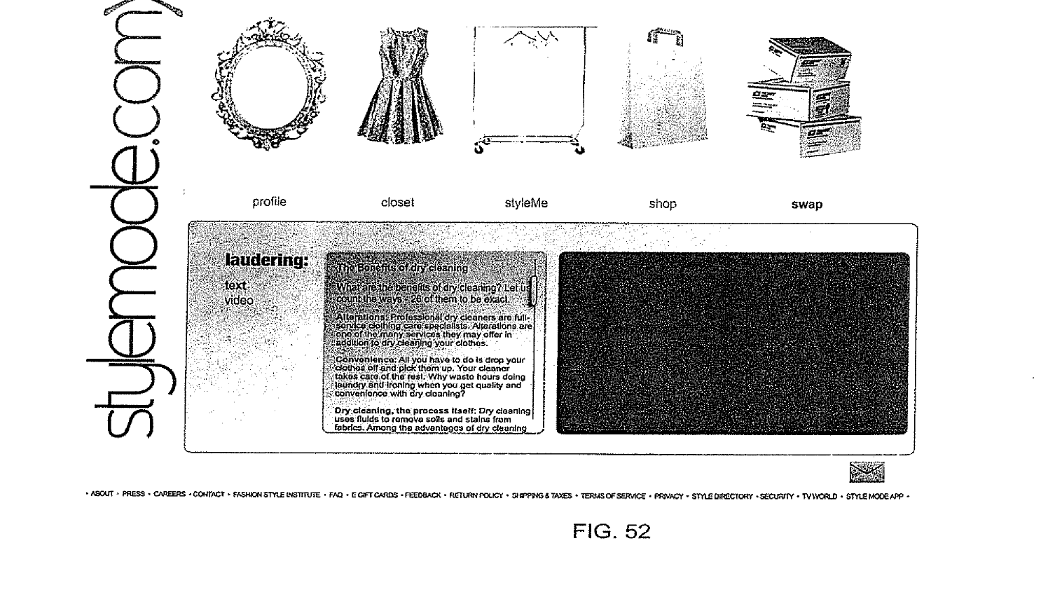

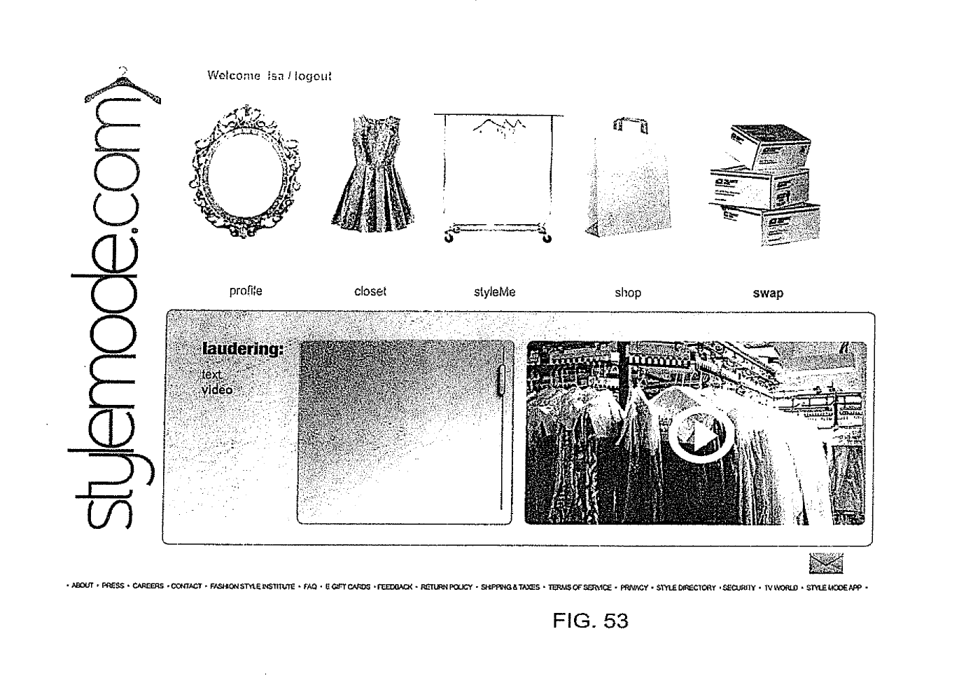

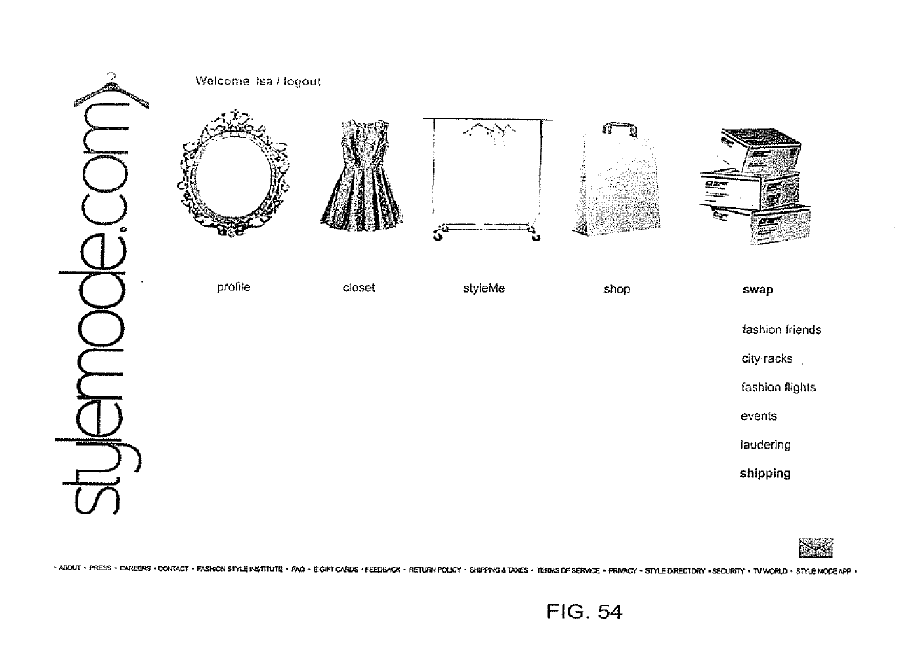

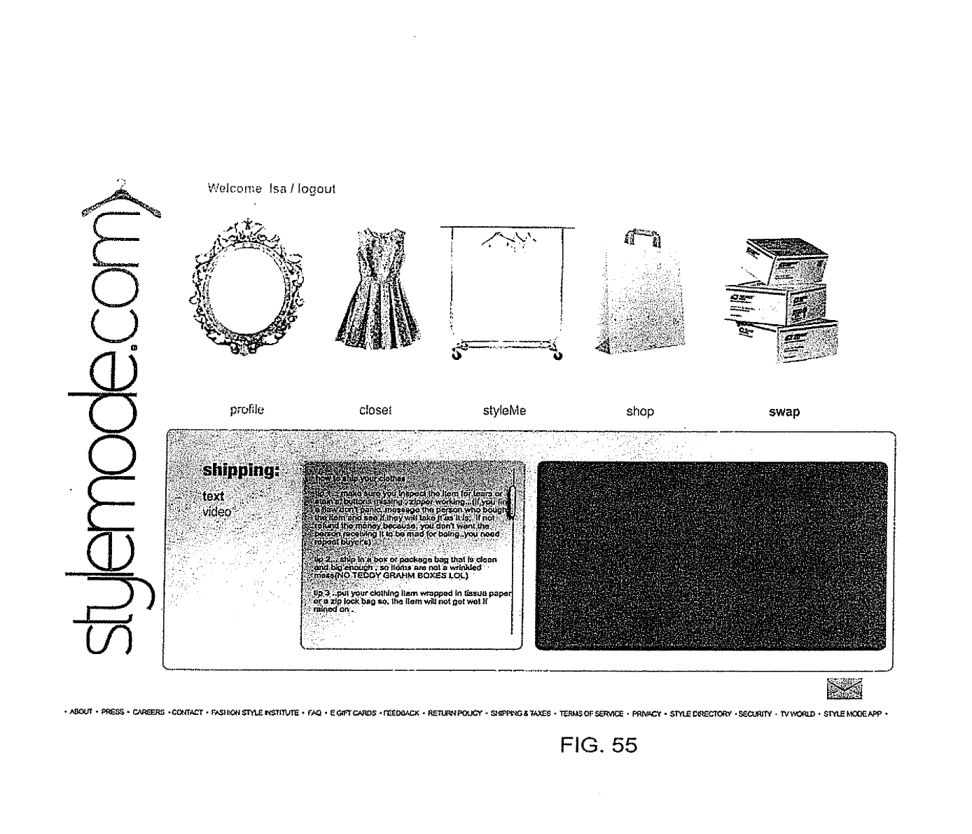

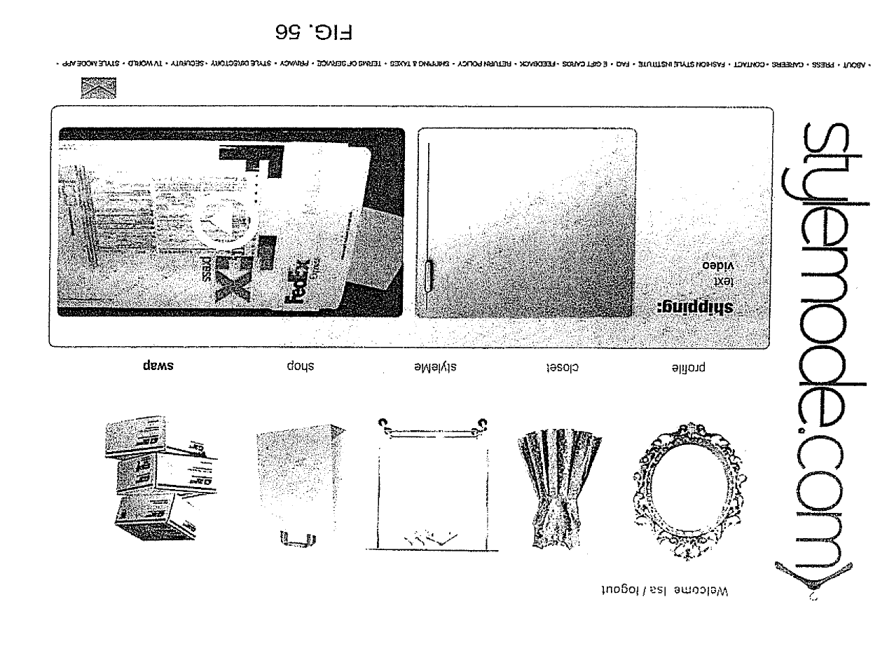

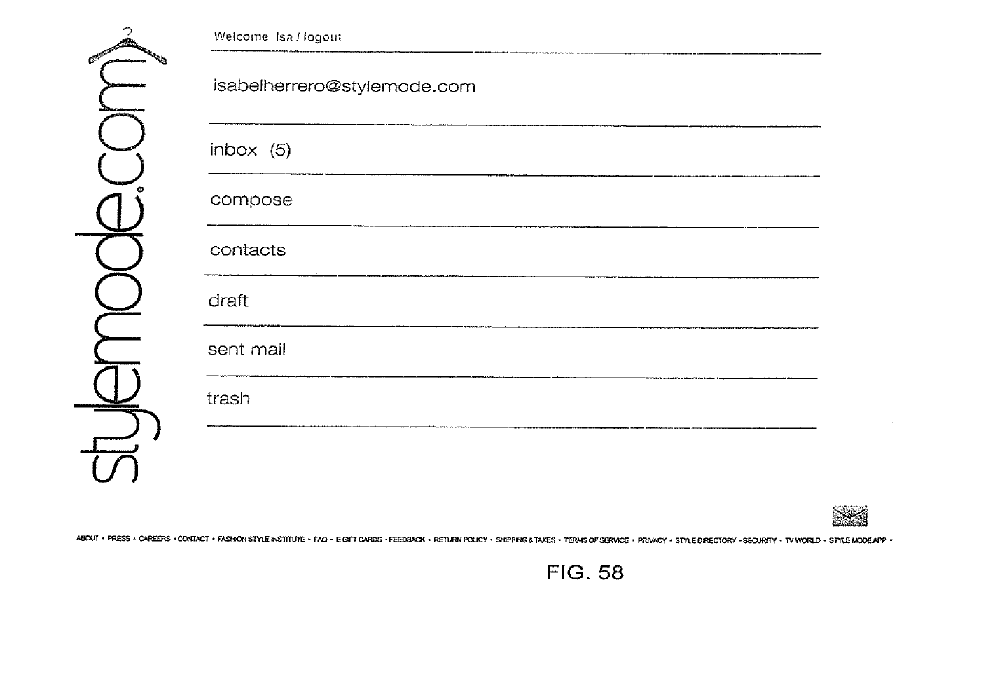

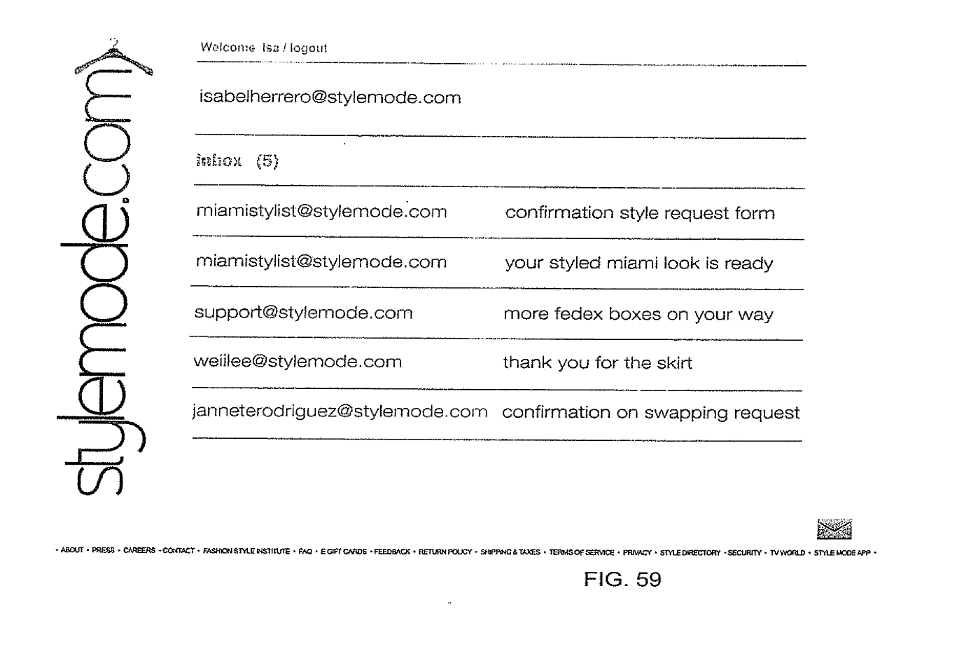

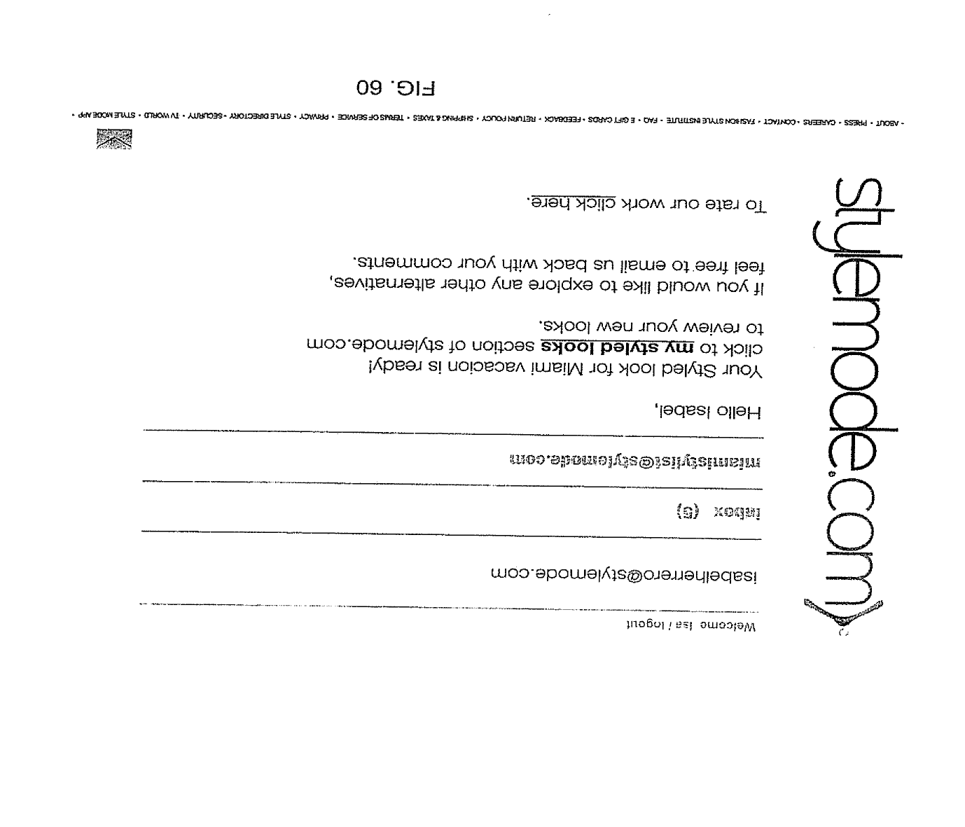

In FIG. 3A and 3B, the end user functionality modules are described in detail. The functionality descriptions are combined with example user interface showings in FIGS. 9-62. At the home page of StyleMeWorld network system, a user can access the system through inputting username and password at End User Login 501 which either starts the Registration process 510 or the user's login home page for other end user functionalities depends one whether the user is already registered. Registration process 510 is similar to many other secured web services online that allows the user to create a username and a password and enables the system to verify the security with the user, for example, through a real email account or the verification of a bank account, or a valid credit card account etc. The Registration process may also allow user to identify the user types, an end user, a fashion service provider or a system editor or an administrator. For register as system editor or administrator, further approving processes are involved. General public may be shielded from access to this login functionality as editor or administrators. It is likely that a membership fee may be charged for each selected and successfully registered user types. Similarly, it will be recognized that other business arrangements are incorporated here; including, operating without a fee, with a partial fee, with a sponsorship/recommendation discount for other enrollees.

The above described login process is by example only, other login processes may be incorporated and developed as needed and as technology develops, new technology will be employed for authentication and authorization process for user registrations and verifications.

Once login as an end user, the user has access to module functionalities of Profile 520, Closet 530, StyleMe 610, Shop 630, Swap 650 and Message System 670. The modules and functionalities may be implemented as independent plug-ins or groups of separately organized objects or Java Beans (for example), and deployed on several machines or over the network (or “distributedly” as it is called in software programming) and connected and integrated together for a full StyleMeWorld experience. An example user interface is shown in FIG. 9.

Profile 520 module provides a group of functions 525, may be implemented by object oriented programming language, such as Java, C and C++ and other newly developed software languages. To activate Profile 520 module to start editing or building a personal profile, a user clicks on the Profile button as shown in FIG. 9 and he/she is prompted to answer a group of fashion related questions, such as hair color, eye color, skin type, profession, geographic location to identify at least the city residing, age group, religious believes, ethnic groups and body types in addition to a nick name and gender information and user contact information.

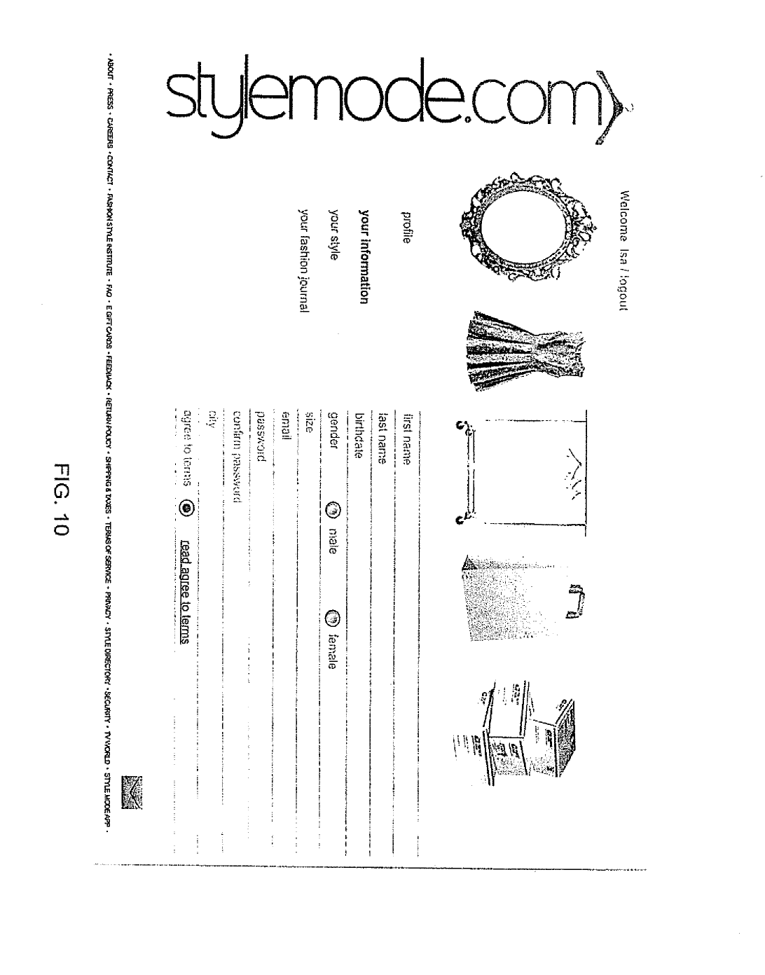

Fashion style questions may ask the user what are the favorite styles, what are the favorite TV show, movie, eras, books, music and any favorite hobbies, favorite fashion stylists and gurus, favorite brand names, etc. A user may identify more than one style as favorite. A user may also add relevant information not asked by the system in the notes area. Example user interfaces are shown in FIGS. 10-12.

An “agree to terms” button as shown in FIG. 10 will need to be checked in order to activate the usage of the full functionalities, and to conduct any transaction related activities. Without checking this button, no transactional process is activated and the user may be limited to only be able to skim through the system.

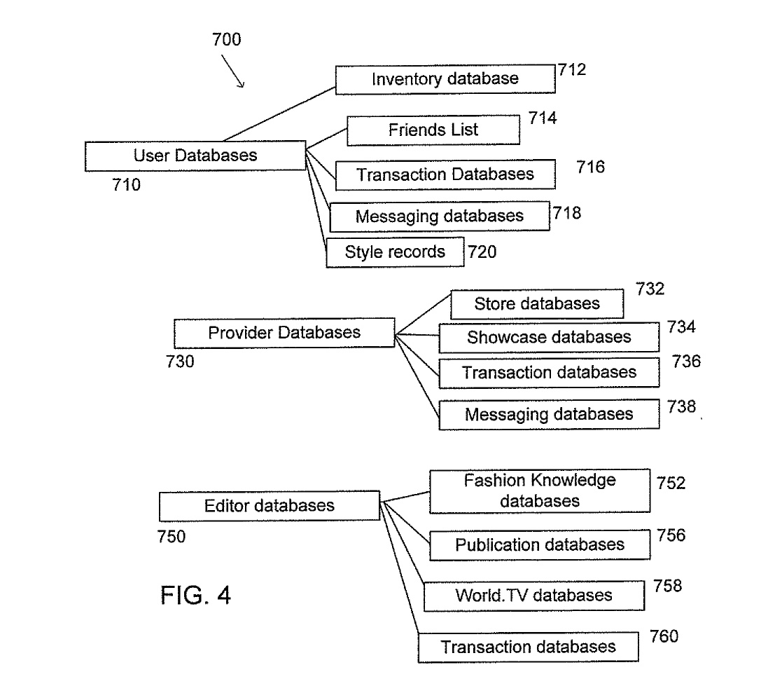

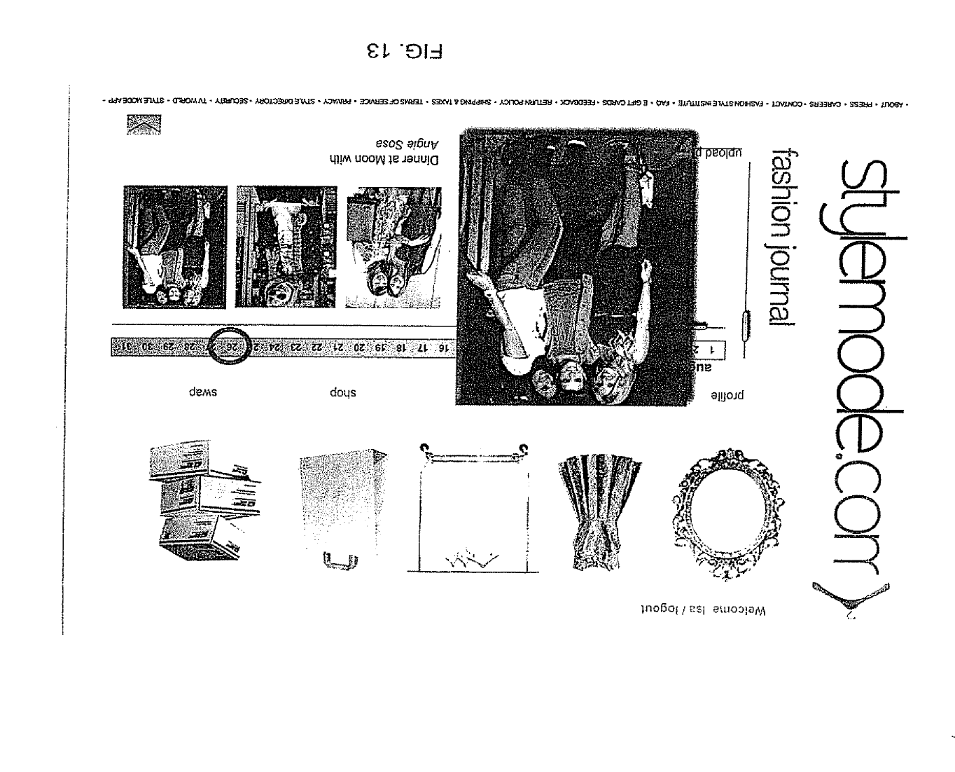

In addition, a user may record his/her fashion moments in his/her fashion journal, for example, as shown in FIG. 13. In building the journal, a calendar is provided and users may upload photos, sketches, and videos and writing notes into the journal. These data are then stored in the database 720 as shown in FIG. 4 with a timestamp and an id associated with the user for searching and retrieving later.

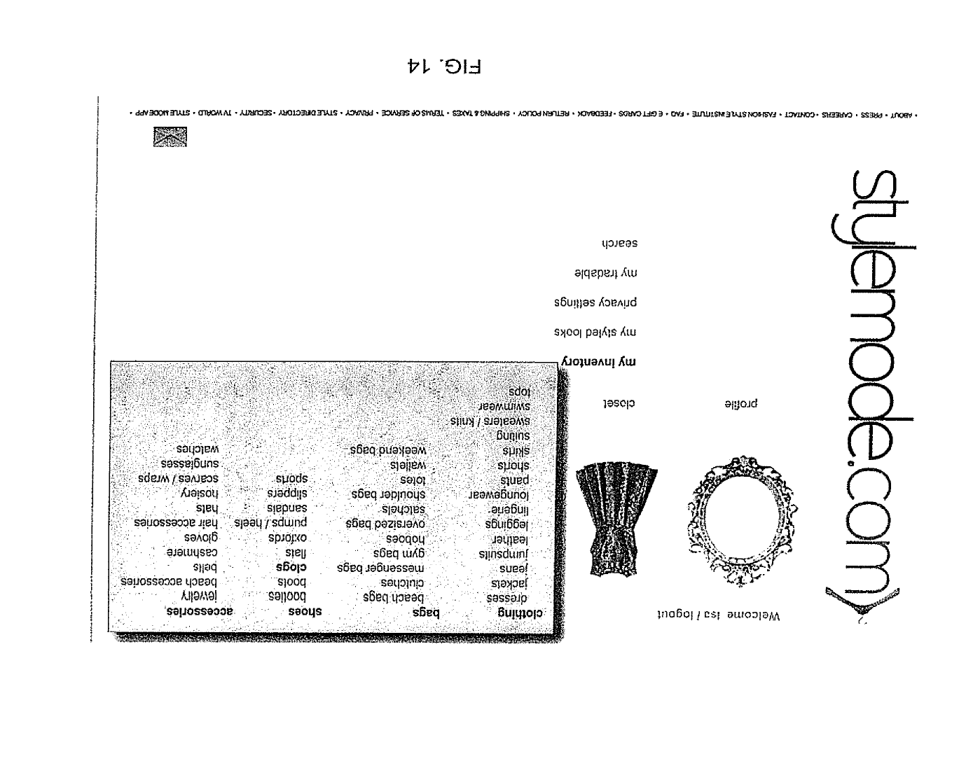

By clicking on Closet module 530, a user is prompted to either build the closet through the functionality of “my inventory” 531, or to build a style using items in the closet through the functionality of “my styled looks” 533, or to allow access to the closet by setting “privacy settings” 535, or to pick items in the closet for trading my functionality of “my tradable” 536, or to search the web or the system databases for interested items to add or purchase through “search” engine 537. Example user interfaces of these functionalities are shown in FIGS. 14-21.

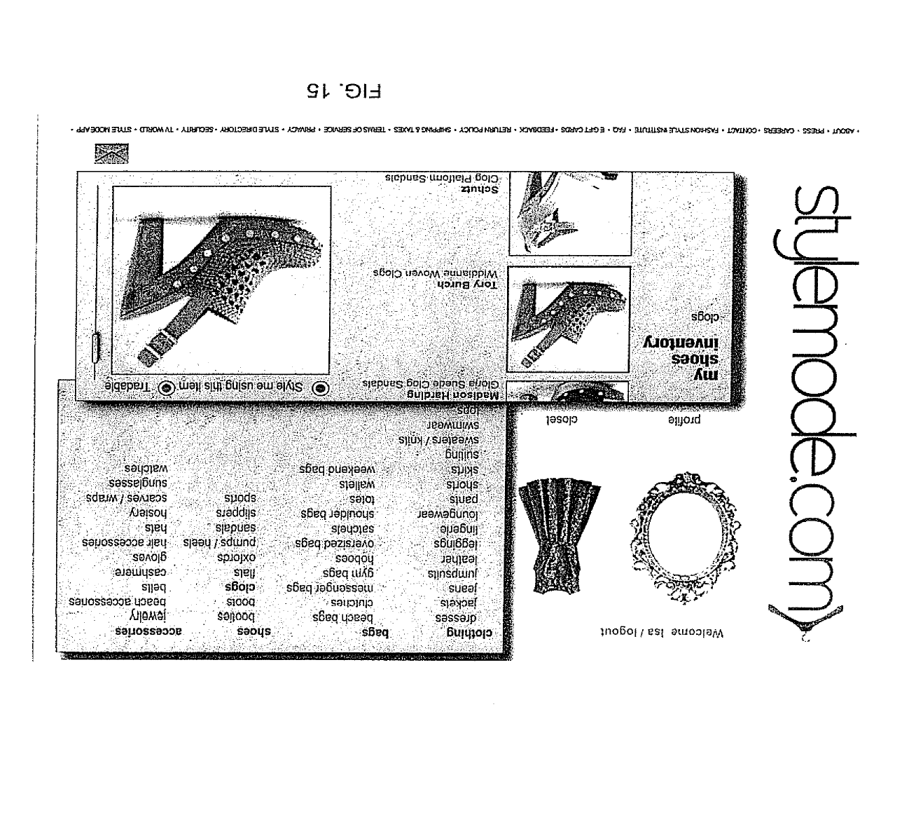

In “my inventory” function platform 531, a user can build an inventory based on his/her real closet, by clicking the categories provided by the system as shown in FIGS. 14 and 15. The user can also upload pictures of his/her items and provide a description of his/her own. For each inventory item, a user can mark this item for trade as tradable or select this item for a look-and-style match in “my styled looks” 533. By selecting an item in “my inventory”, the user has the option to either mark it as a tradable or to place it in “Style Me” so that a stylist may make suggestions as to a matching outfit.

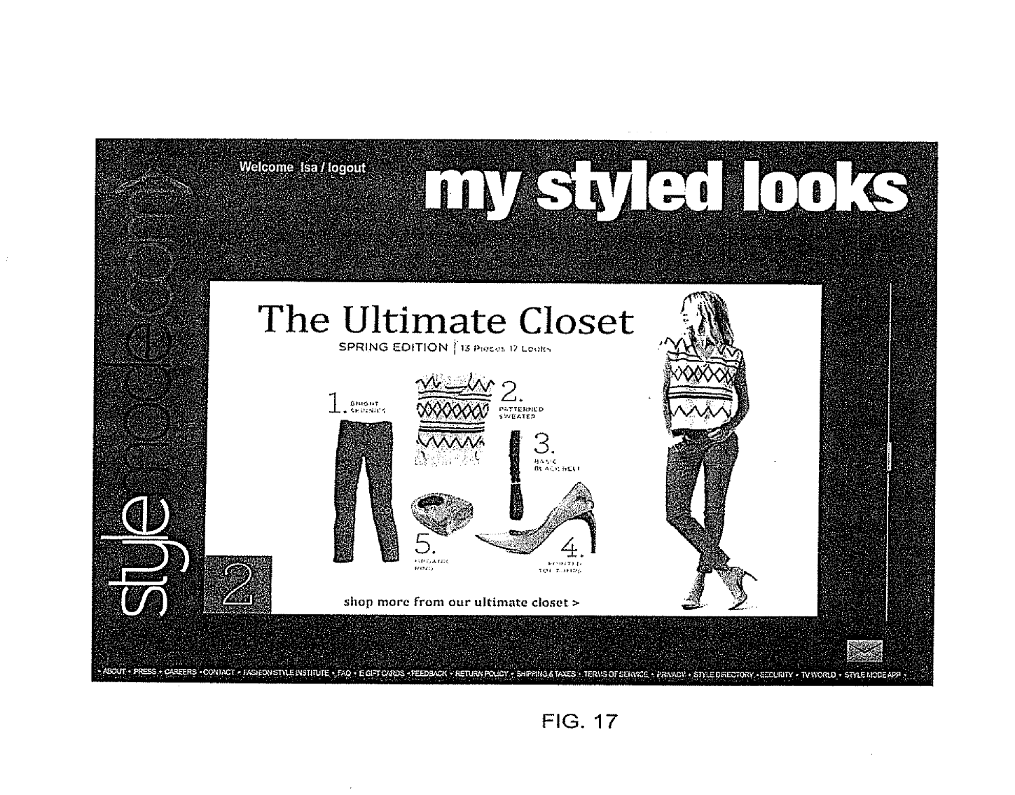

Platform “my styled looks” 533 represents a personalized virtue fitting room, allowing a user to pick various items in the closet to match for various fashions. A virtual mannequin may be built by functionality 538 according to the personal information provided in the profile and various fashion items may be selected from the closet to be displayed on the mannequin. The method for building such virtue clothing display is known in the art, for example as described in US patent Application Publication Nos. US 2011/0218664 A1 and US 2009/0018926 A1, both of which are hereby incorporated by reference for background technology for implementing such a user interface. Platform “my styled looks” 533 also provides a link to the “shop” utility 630 for further shopping an item that is not in the closet. FIG. 17 shows an example user interface of “my styled looks” 533. This shopping may be guided automatically with recent fashion trends collected by the system or by a specialist/stylist for a conscious style matching, not just simply random shopping.

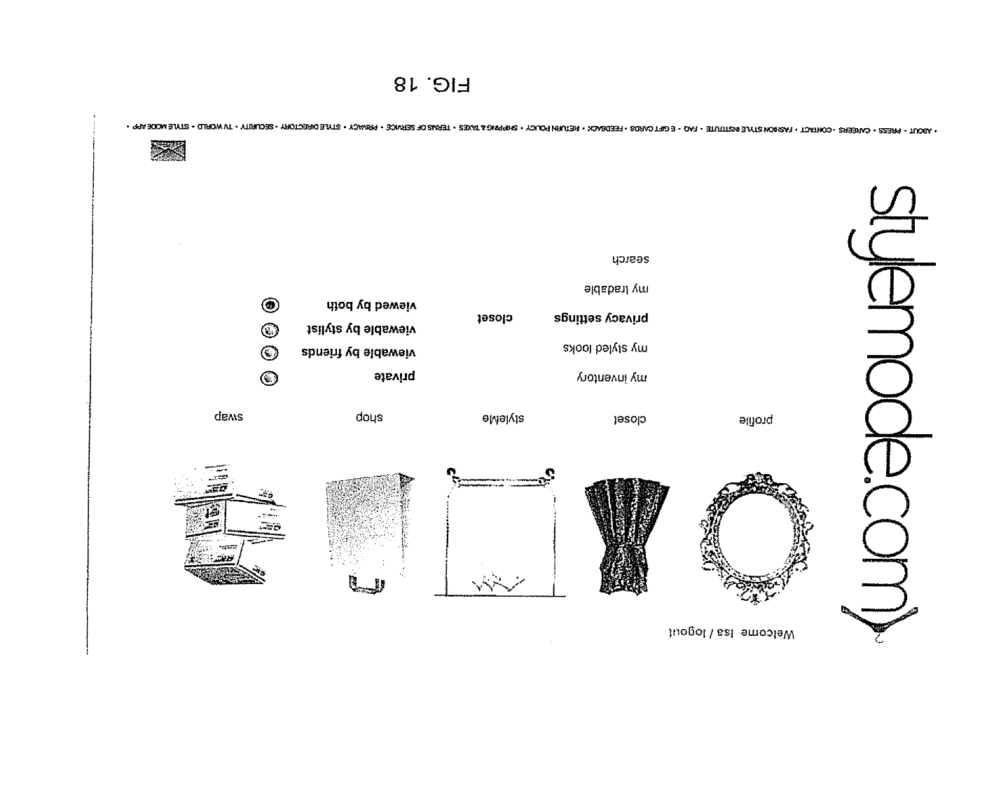

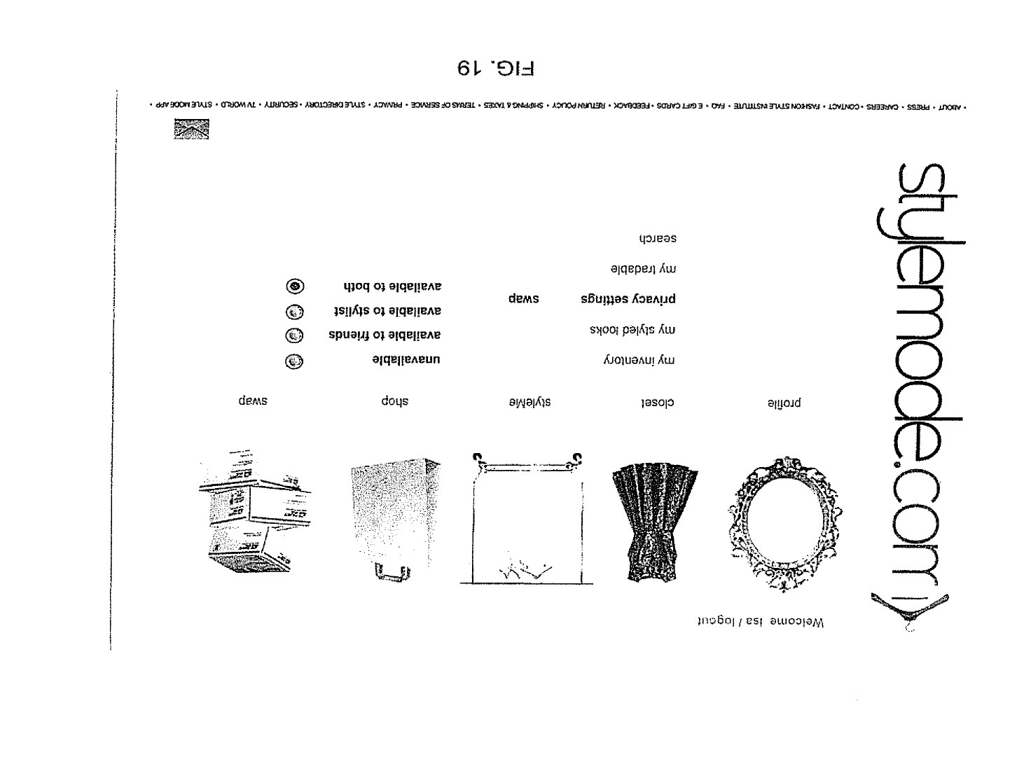

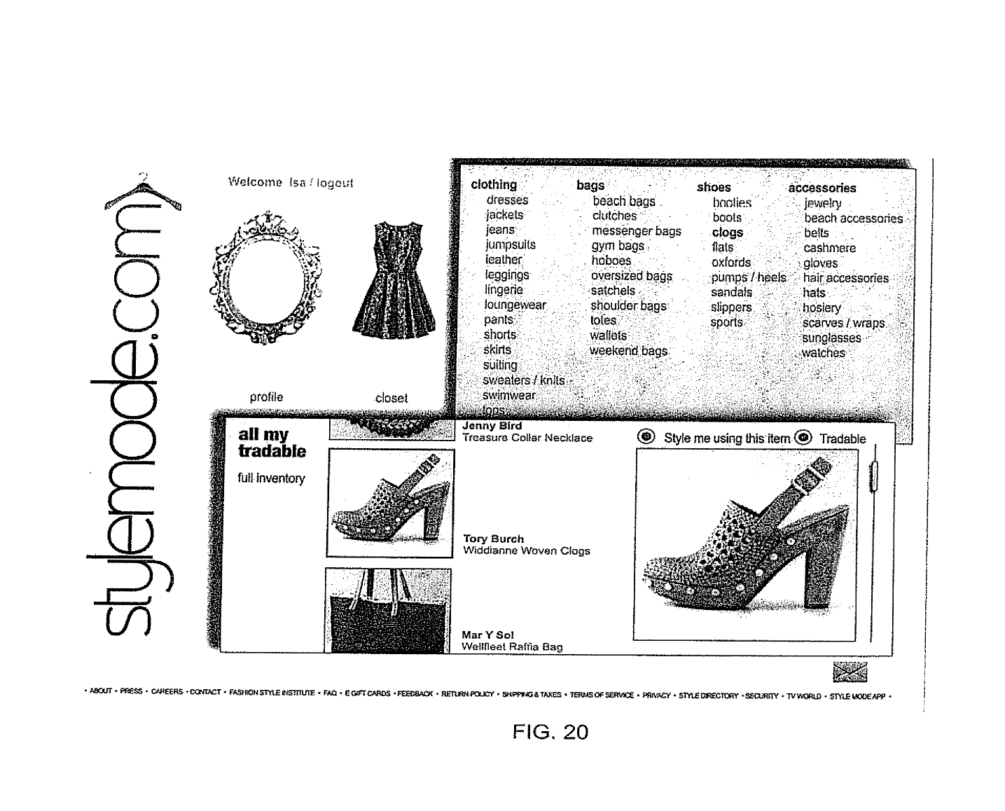

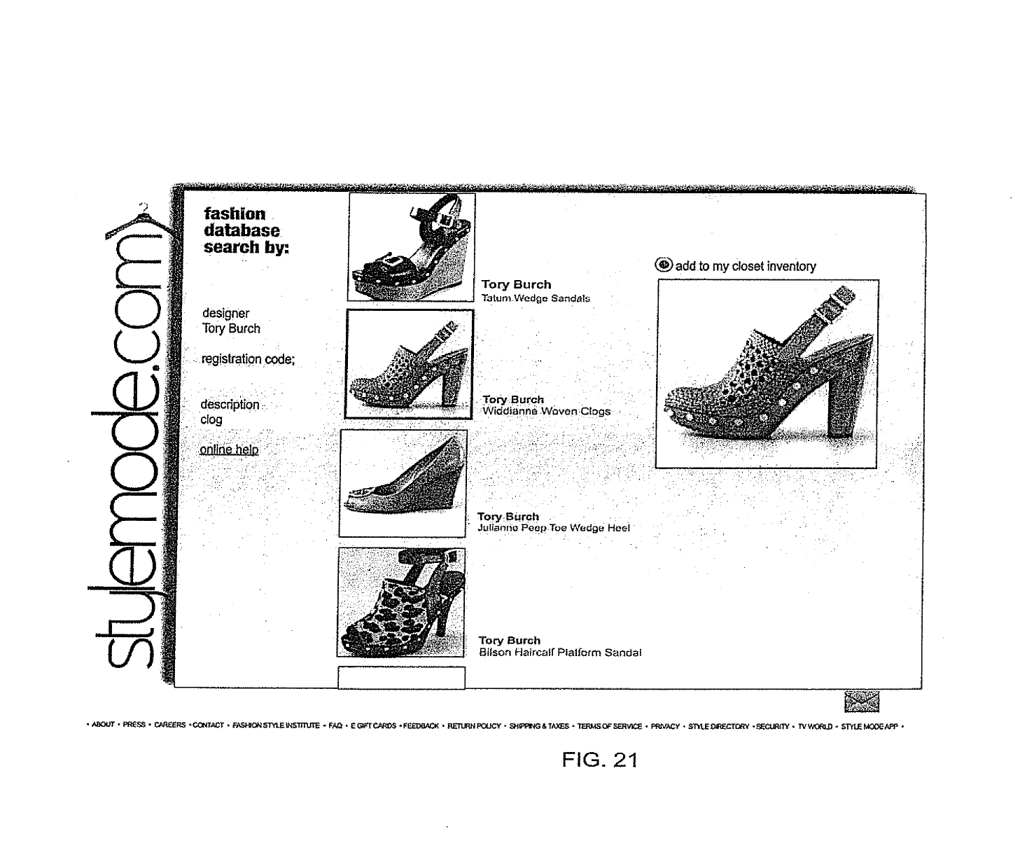

Button for “privacy settings” 535 may be clicked to set the accessibility of the closet, a user may restrict the closet to be viewable only to close friends, to stylist or just temporally to a group of people by functionality 539. The closet may also be marked for “swap” function and may restrict the swapping functions to be between friends, with a stylist or both. FIGS. 18-19 show examples of settings. “My tradable” functionality 536 however displays all items marked as “tradable” in the closet to all members and may be searchable on the whole internet. FIG. 20 shows an example user interface. “Search” engine 537 allows a user to search the store databases of the system or stores on the internet by designer name or by brand name or keyword. FIG. 21 shows an example user interface. Both “My tradable” platform 536 and “search” engine 537 are linked to the trading engine 540 to perform trading transactions for the user online, which may include paying account management and/or credit card processing and shipping tracking.

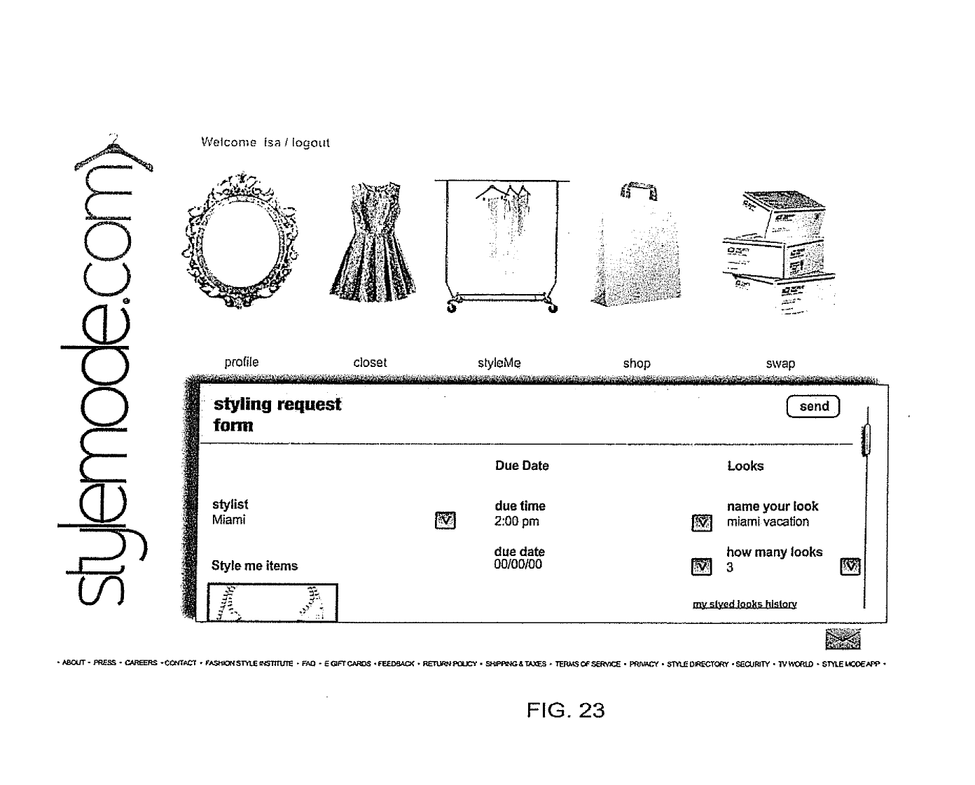

In reference to FIG. 3B, a “StyleMe” functionality 610 is implemented for a user to seek for professional suggestions and style opinion with the convenience of the internet speed and without going out of the doors by either parties. With this functionality, a user can send a request to a registered fashion service provider or a stylist using a form provided by the system to set a time for communication and/or to grant access to his/her closet. A stylist then can find this client in the system and click on this client's closet to take a survey of the inventories and to provide a fashion or style opinion/suggestion for the client, perhaps for a particular event or activity. FIG. 23 shows an example user interface for sending a request. The platform also keeps track of request history for a stylist to check for reference, for example a stylist may not want to have the client to have a similar style too often, or to wear the same clothing to the same event each year. A stylist may also suggest a link of an item for the user to look into and/or to purchase or to swap with. For example, there may be identified *(shop key items) meaning the key items that the personal stylist has recommended for a user to add to their closet. Such a recommendation may come from any linked communication pathway, including but not limited to any person, stylist, fashion designer, fashion guest, etc. working in the company or a consultant or any other person the company selects as an expert- that is reasonable to link in making such a recommendation or suggestion on behalf of the company or supplier.

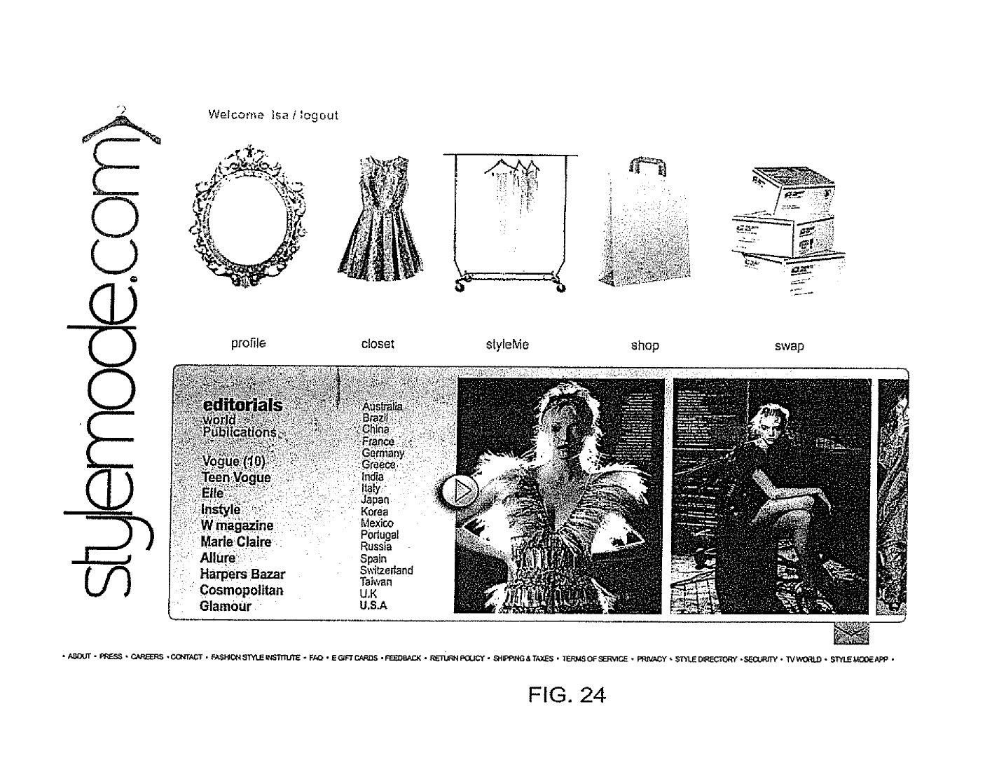

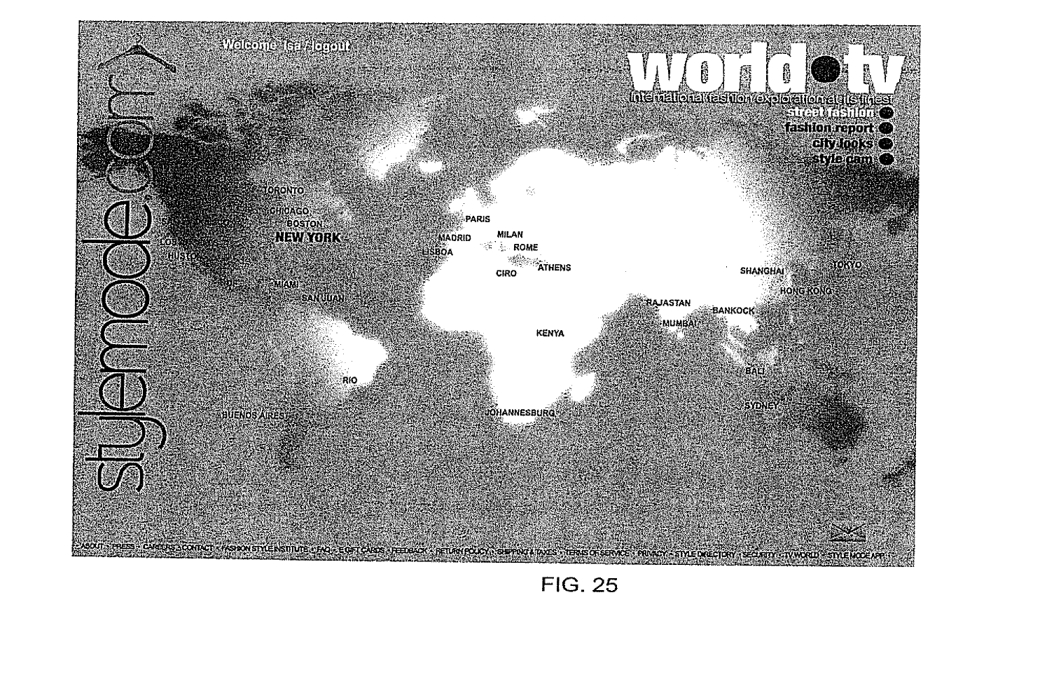

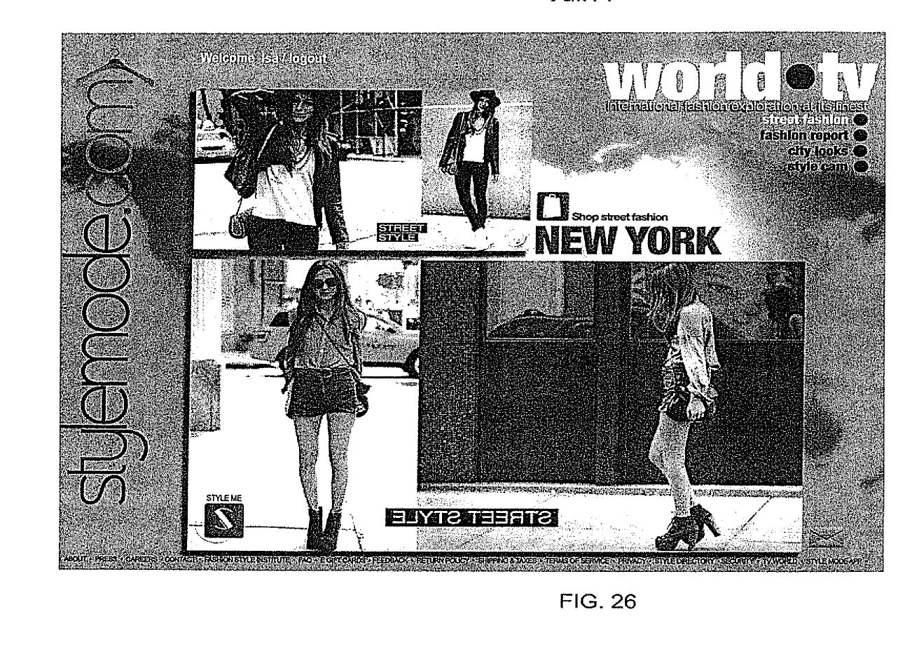

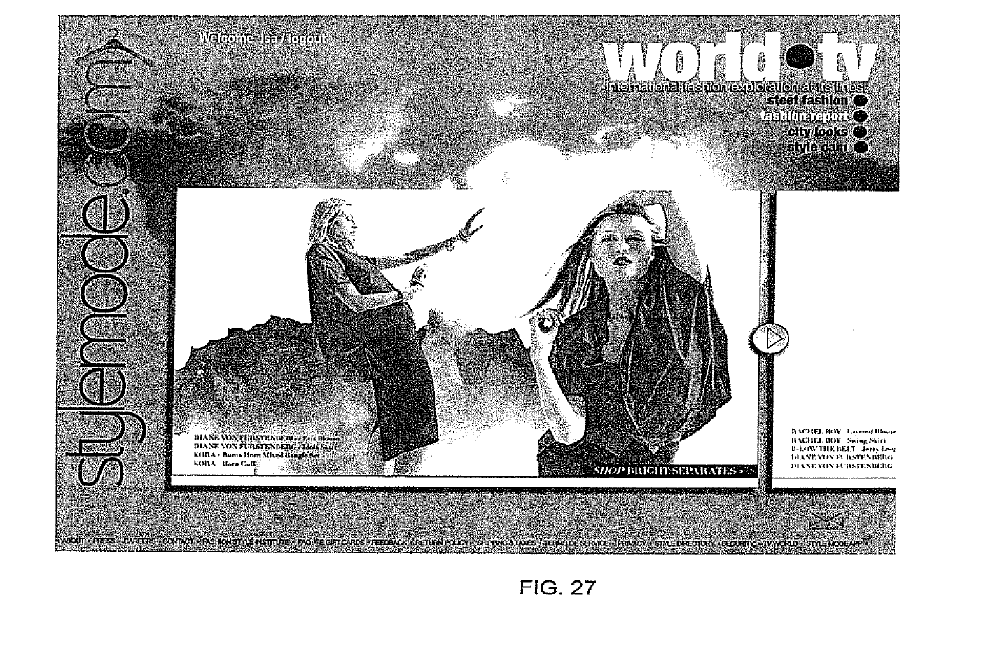

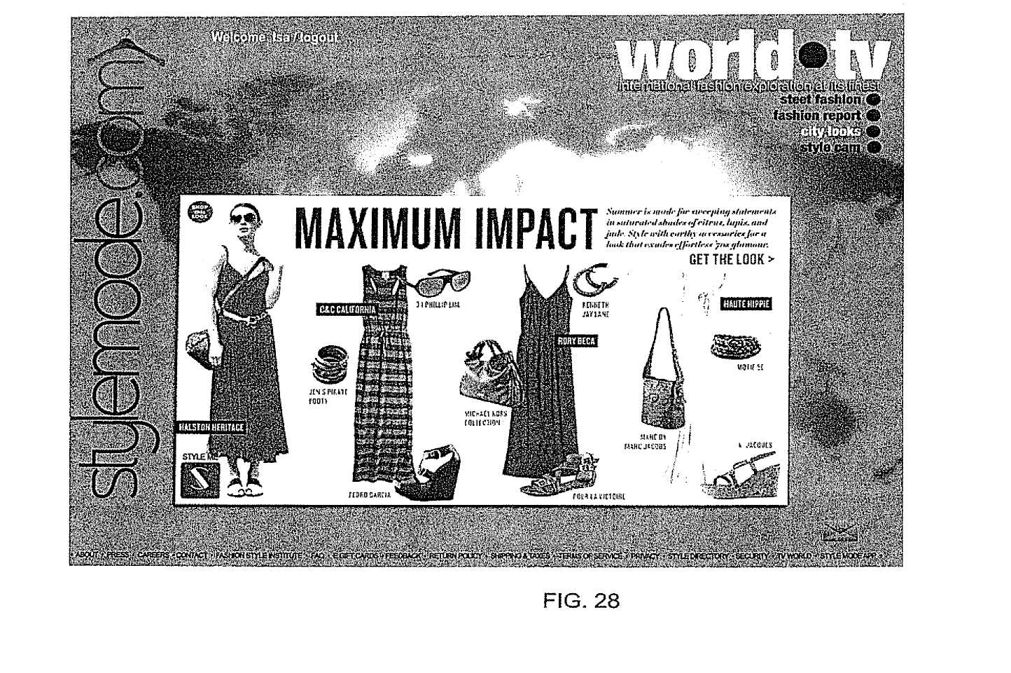

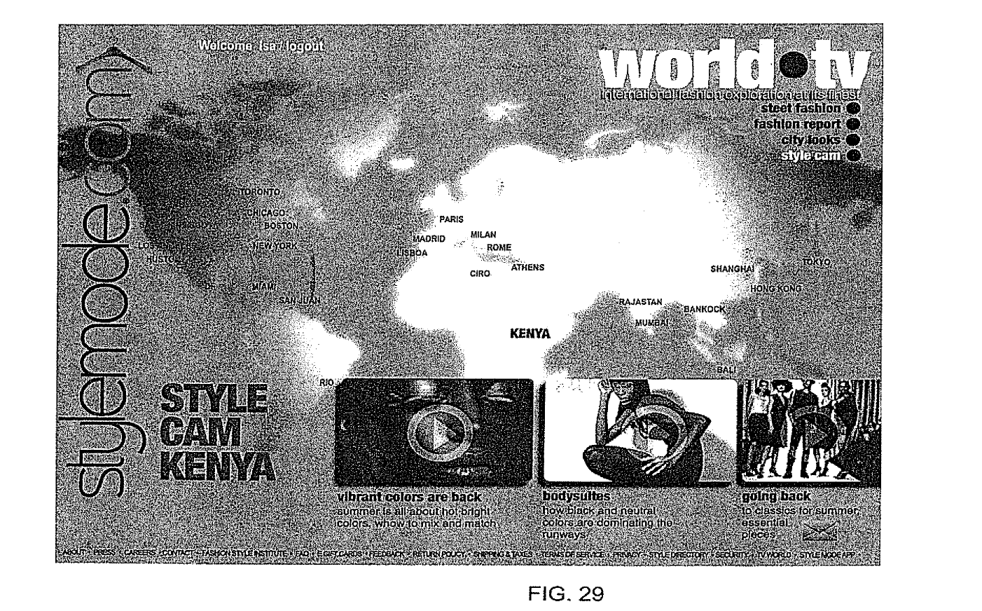

In addition, “StyleMe” 610 also includes “editorials” functionality 612 for fashion publications and World.TV functionalities 613 for a multimedia showing of world fashion trends by one clicking as shown in FIG. 25. FIG. 24 shows an example user interface of editorially providing a collection of fashion publications with youtube® *or any other video viewing program (video technology) available now and in the future, that would improve companies service streams and web links. FIGS. 25-29 show example user interfaces for multimedia fashion trends on TV, shows and on streets. Youtube® streams as well as fashion channels on TV are incorporated and displayed in this portal. Street fashion may monitor the streets of a particular city as shown FIG. 26, and fashion report generated by system editors may be shown as in FIG. 27 and a city's spectrum of trends may be summarized by system editors as shown in FIG. 28. A world panorama of fashions is provided through StyleCam platform which displays fashion related multimedia provided by reporters and users on the internet around the world as shown in FIG. 29.

StyleCam platform also provides the opportunity to any fashion lover and StyleMe client/user to travel streets of any city, to enjoy different styles and perhaps celebrities, a particular social party.

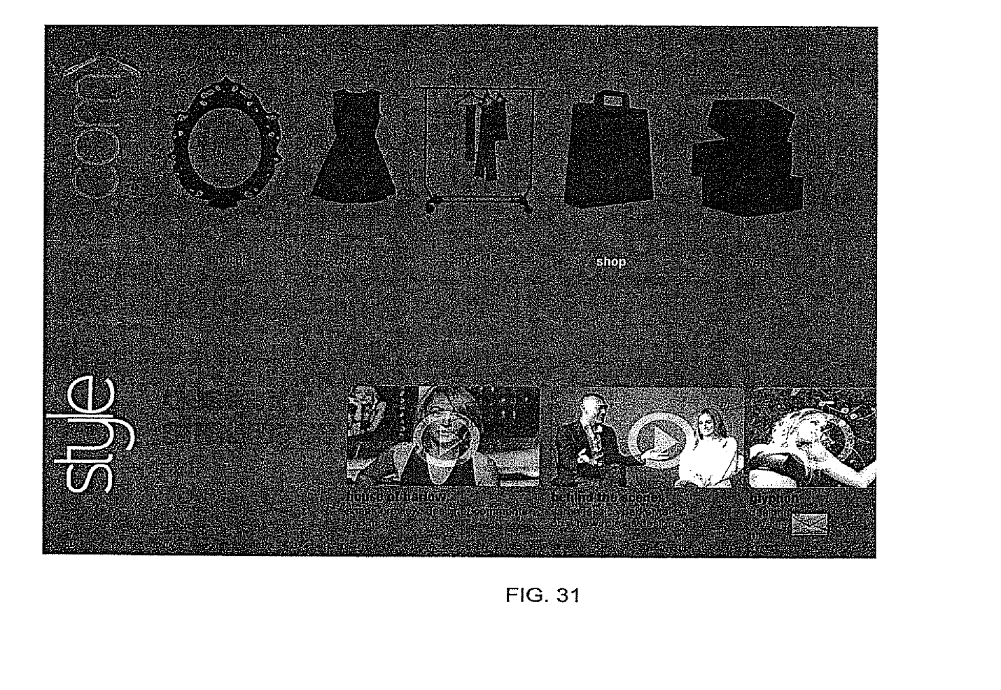

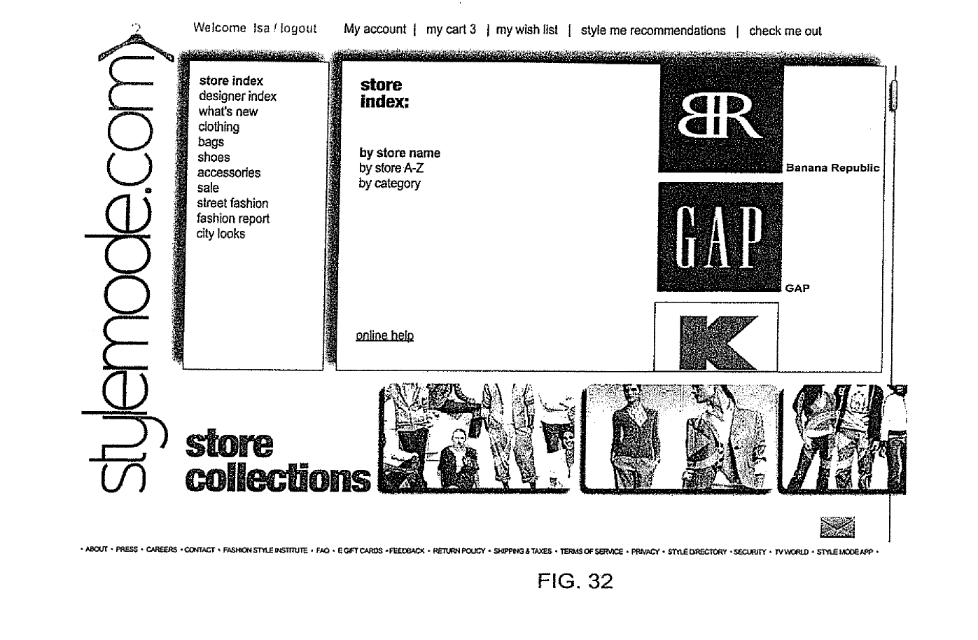

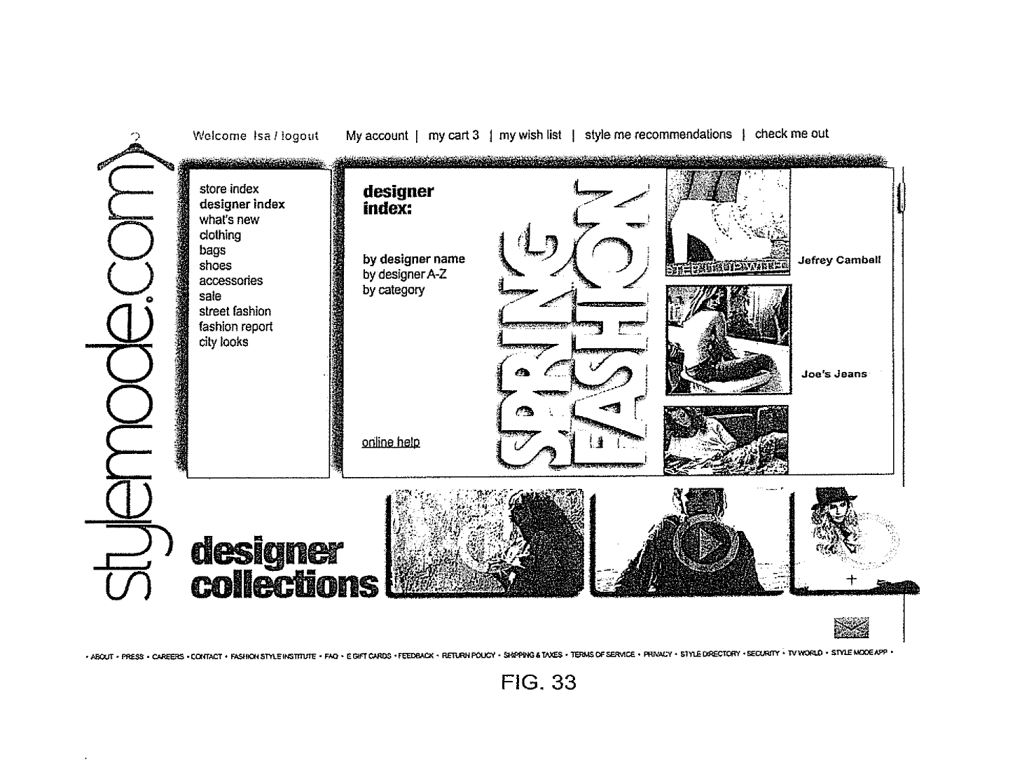

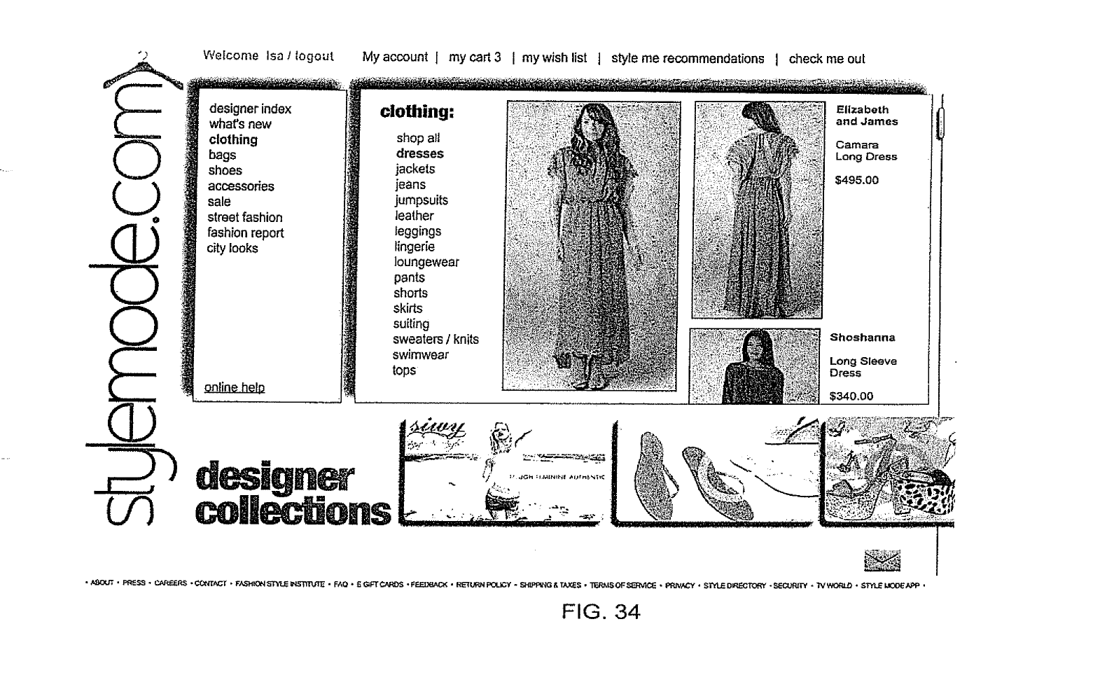

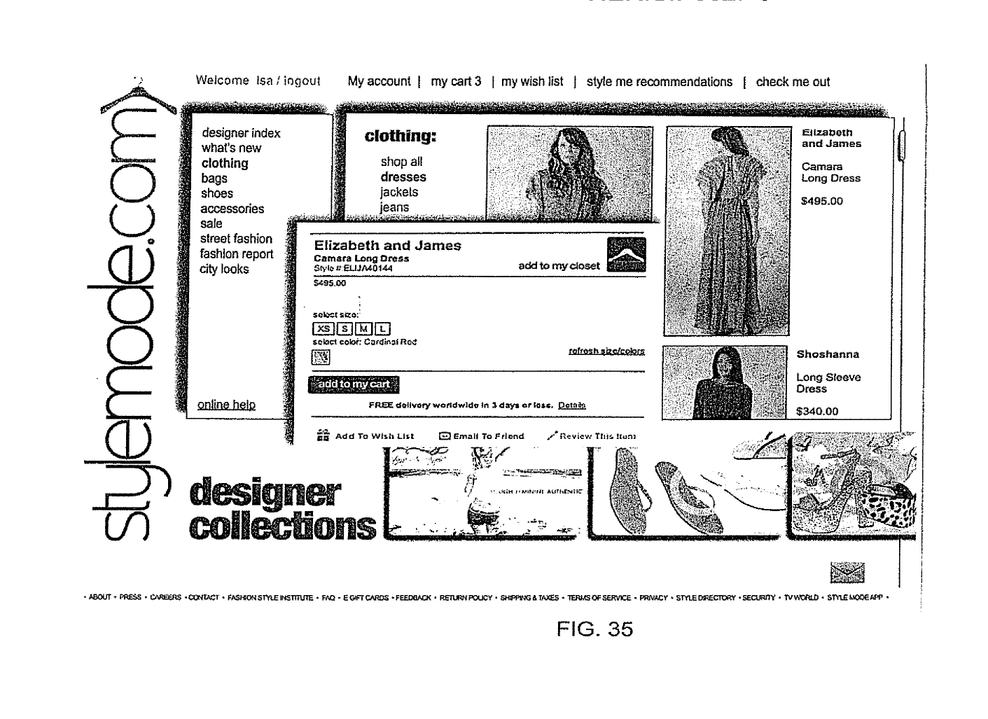

A shopping platform 630 is also provided for a user to shop with the functionality 631 for going through a fashion showcase, functionality 632 for shopping through store name index, by category, by designer name or by “what is new” trends summarized by system editors. Fashion showcases and stores in the fashion mall of the system are built by service provider users. Users and clients will get to know brands and their designers better by scurrying through the designer showcases, the video or text that can take a user behind the scenes of many brands. Through these platforms, a brand will then associate an intimate image of its developers and designers. These stores and showcase materials are stored in provider databases 730 including store databases 732 and showcase databases 734 in FIG. 4. FIG. 31 shows an example user interface for shopping through designer showcases, and FIG. 32 shows an example user interface for shopping by store names and for displaying store collections, FIG. 33 is an example user interface for shopping by designer names and for displaying designer collections, FIG. 34 shows an example user interface by categories and for displaying designer collections by category. FIG. 35 shows an example user interface of the trading engine 540 which has a link to status tracking engine 633 (not shown) similar to those on amazon.com.

StyleMeWorld network system also provides a “swap” engine 650 for registered end users to swap items in the closet with a fashion friend or a stylist on the network. “Swap” engine 650 has functionality 651 that allows a user to identify and invite a user to be a fashion friend, and to build a friends list for chatting and messaging as well as for swapping closet fashion items. Other functions may include searching online friends, accessing friend's closet, making comments on friend's fashion journals, and sending swapping request. A swapping status tracking engine 652 is built into “Swap” engine 650, an similar to trading status engine 633, displays the current status of swapping and links to track shipping status. Functionality 651 also has a City Rack function for searching fashion friends by city with a click on the map and by category.

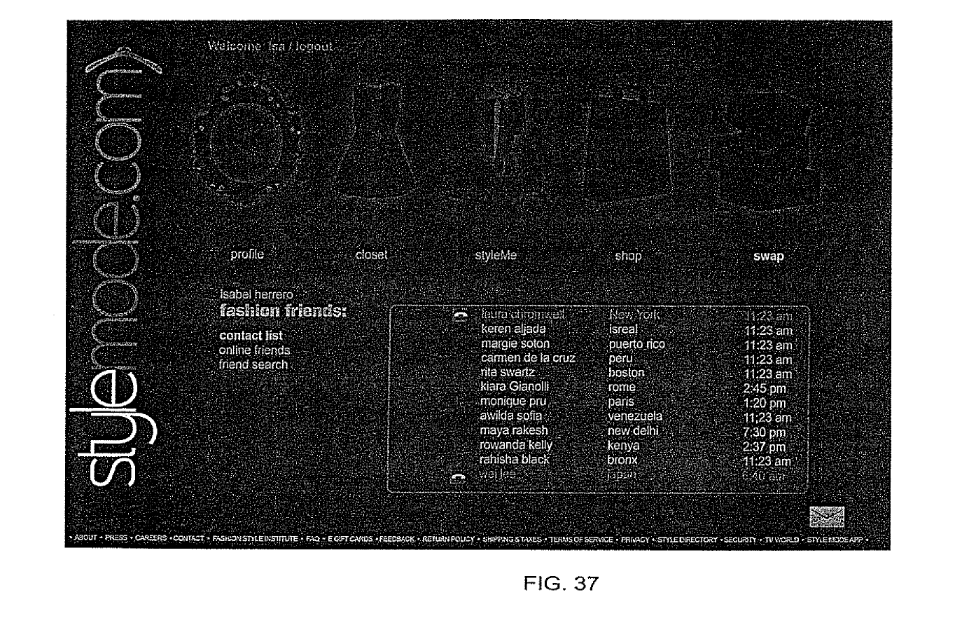

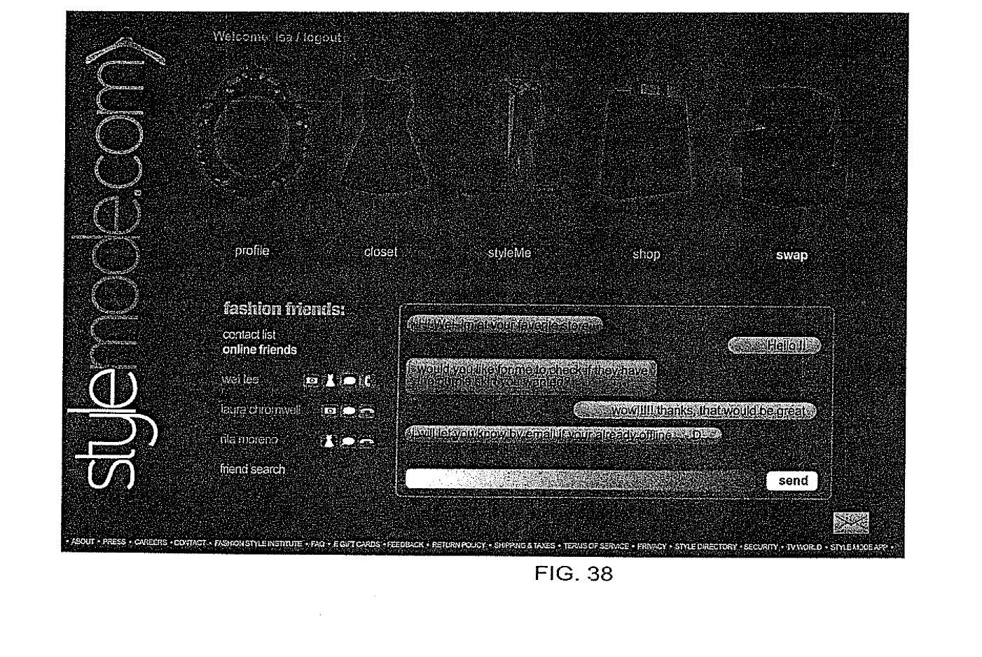

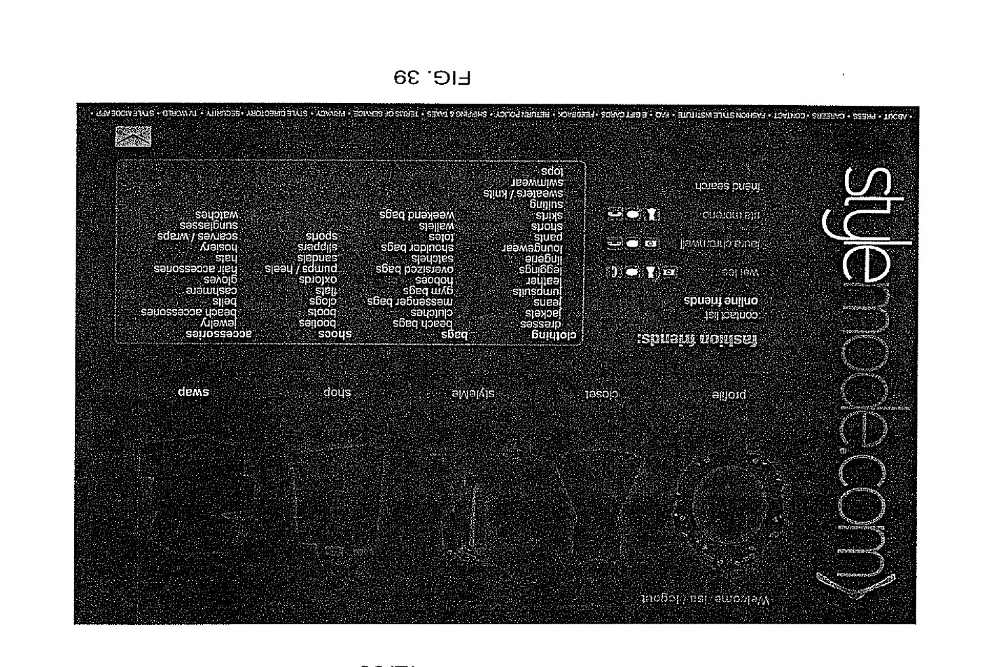

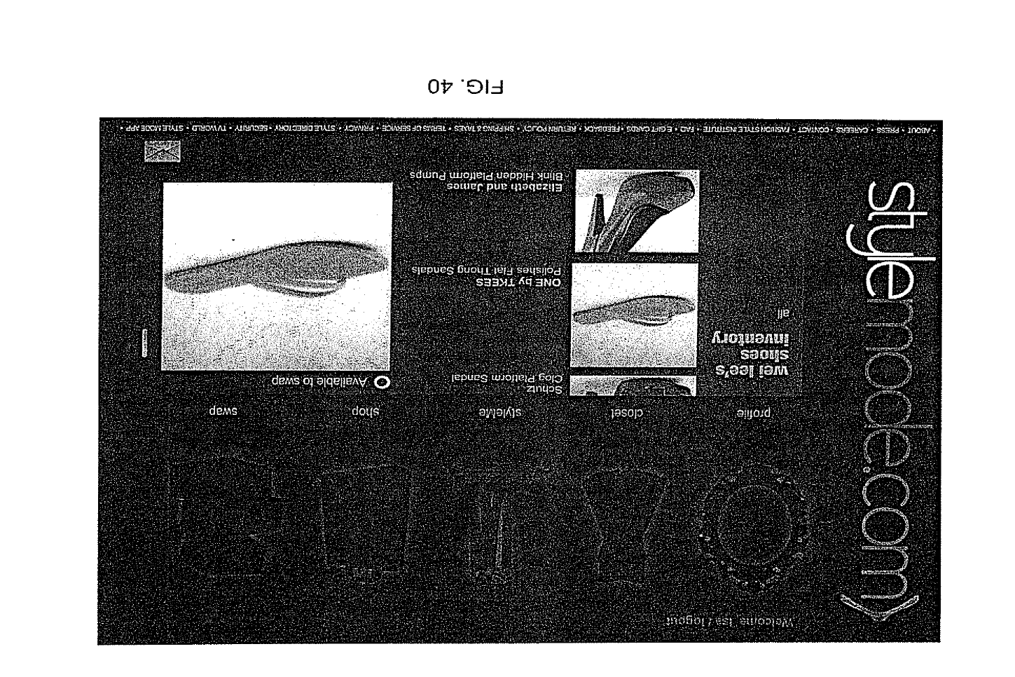

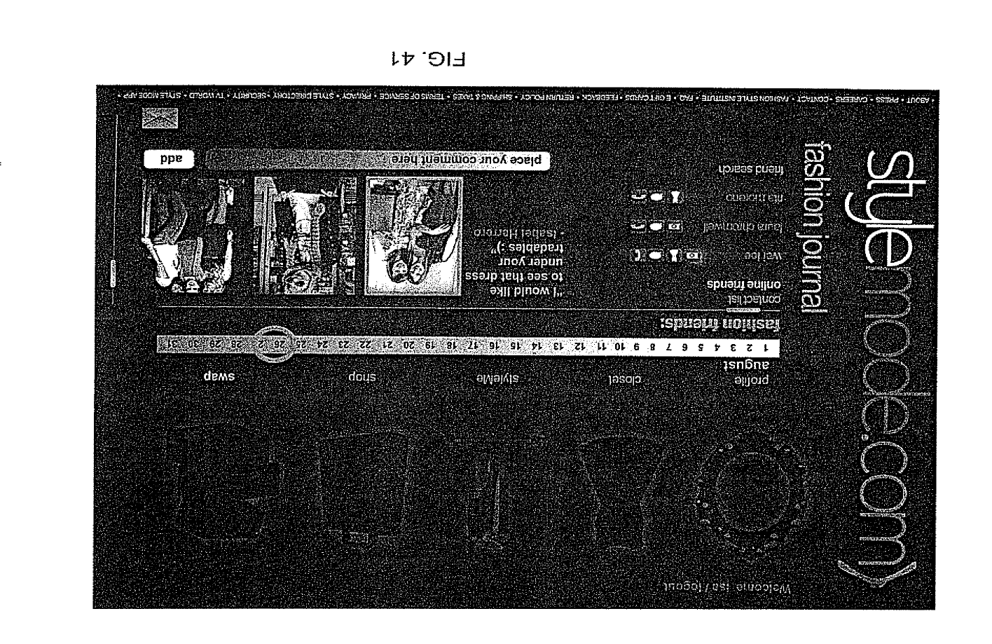

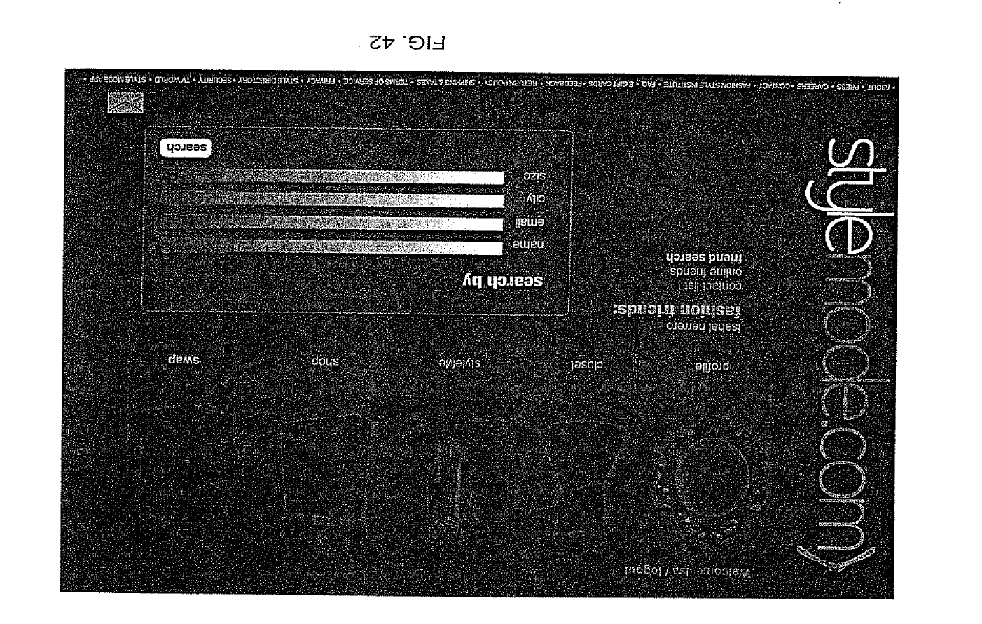

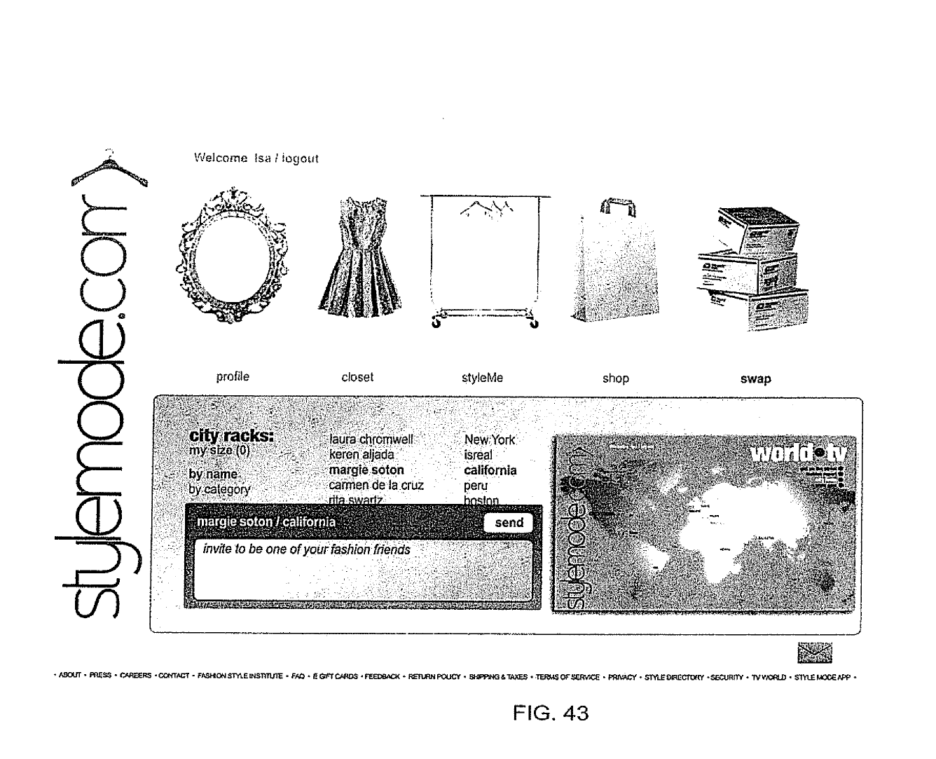

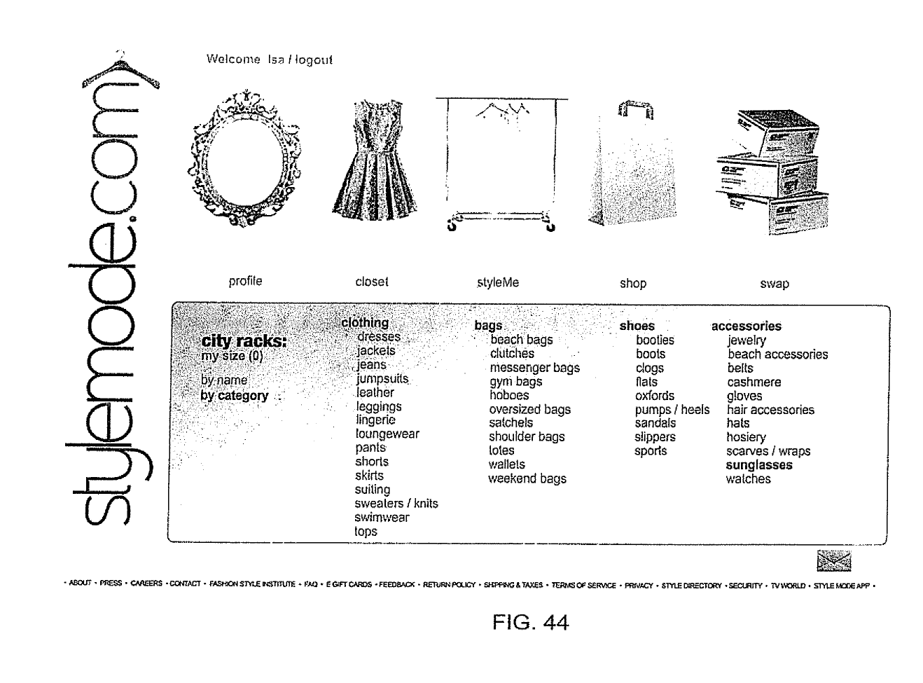

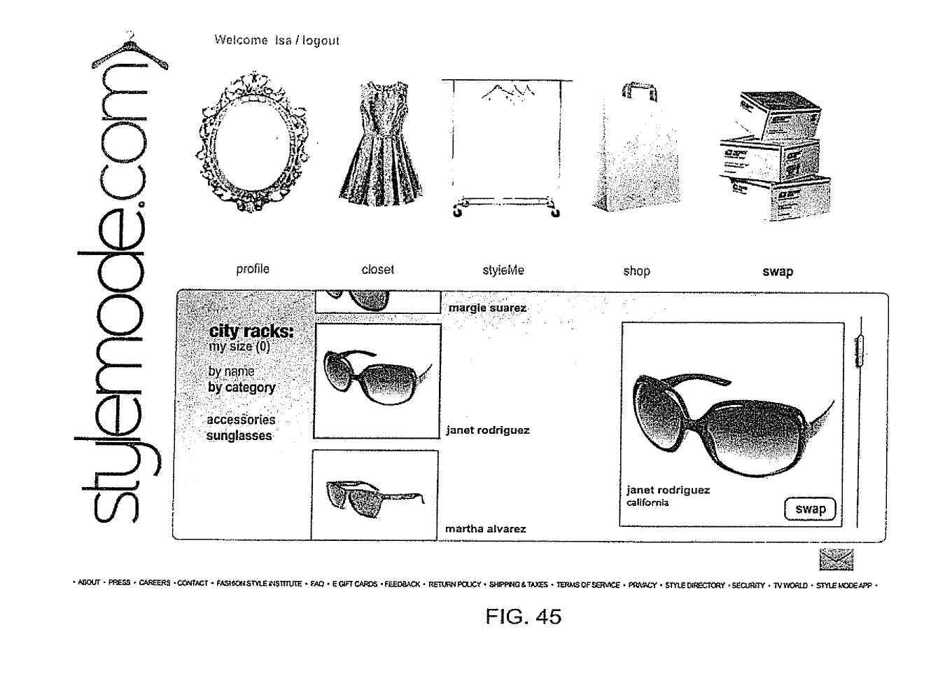

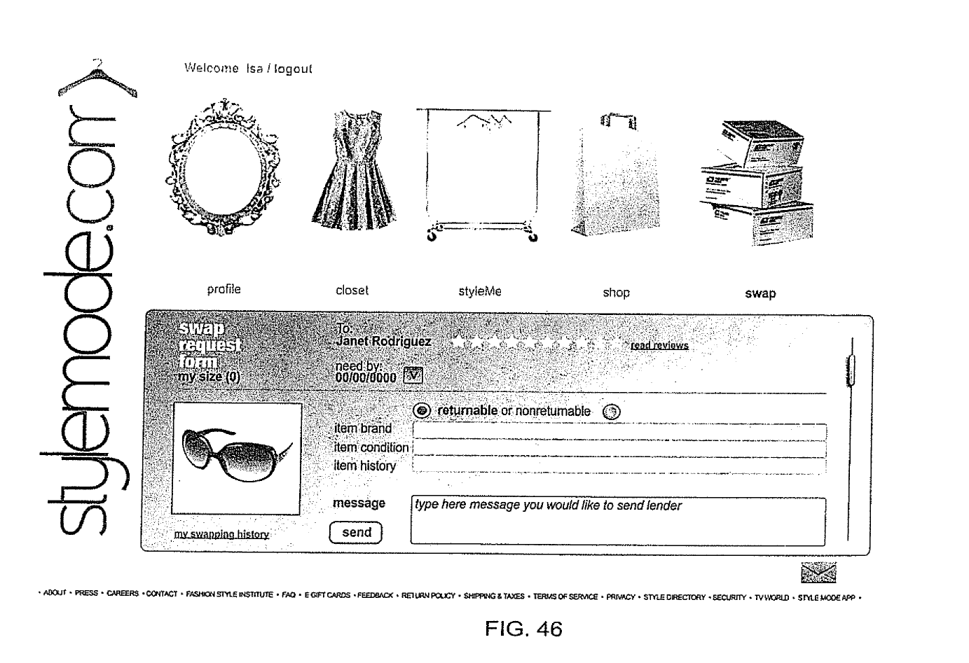

Example user interfaces for functionality 651 are shown from FIGS. 37-46. FIG. 37 shows an example user interface of building a friend list, FIG. 38 shows an example user interface for messaging with a friend, FIG. 39 shows an example user interface of displaying the closet of a fashion friend, FIG. 40 shows an example user interface of displaying a tradable item of a fashion friend's closet, FIG. 41 shows an example user interface of displaying the fashion journal of a fashion friend, and for adding comments to her/his fashion journal, FIG. 42 shows an example user interface for searching a fashion friend, FIG. 43 shows an example user interface for finding and inviting a user to be fashion friend by a geographic location, FIG. 44 shows an example user interface of searching swappable items by category, FIG. 45 shows an example user interface for selecting an item for swapping, FIG. 46 shows an example user interface for sending in a swapping request to the owner of a tradable item.

Swapping may be done by matching of two or more fashion friends, as an additional example, *closets also gets matched by size or any other method that would benefit customers for swapping) tradable item list or matching a tradable item of a user with another user's tradable item list. A point system may also be implemented if no suitable trading partners are matched by the system. Such system is similarly described in US Patent Application No. US 2011/0258069 A1 which uses a point system to mediate swapping. This publication is hereby incorporated by reference for background knowledge description.

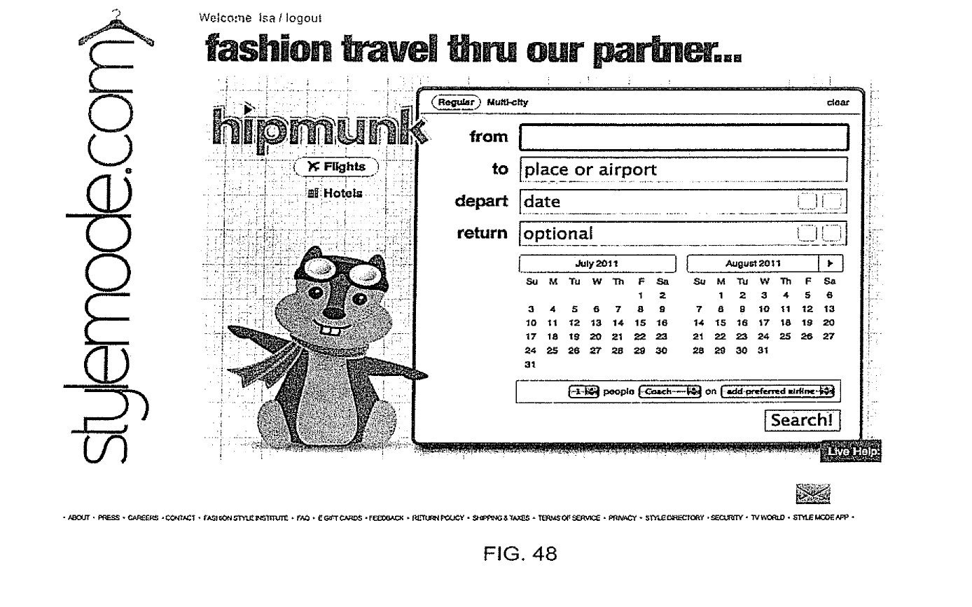

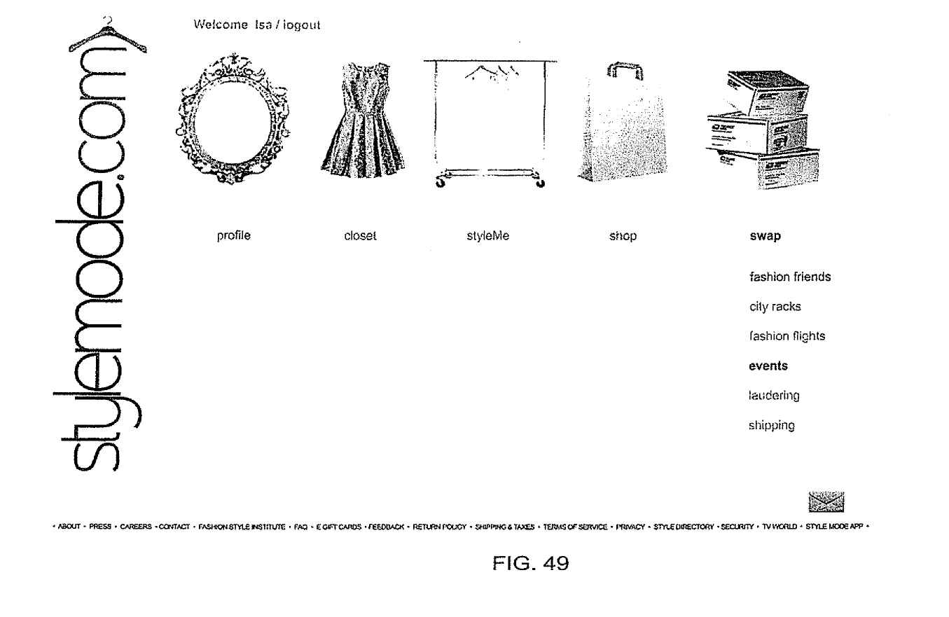

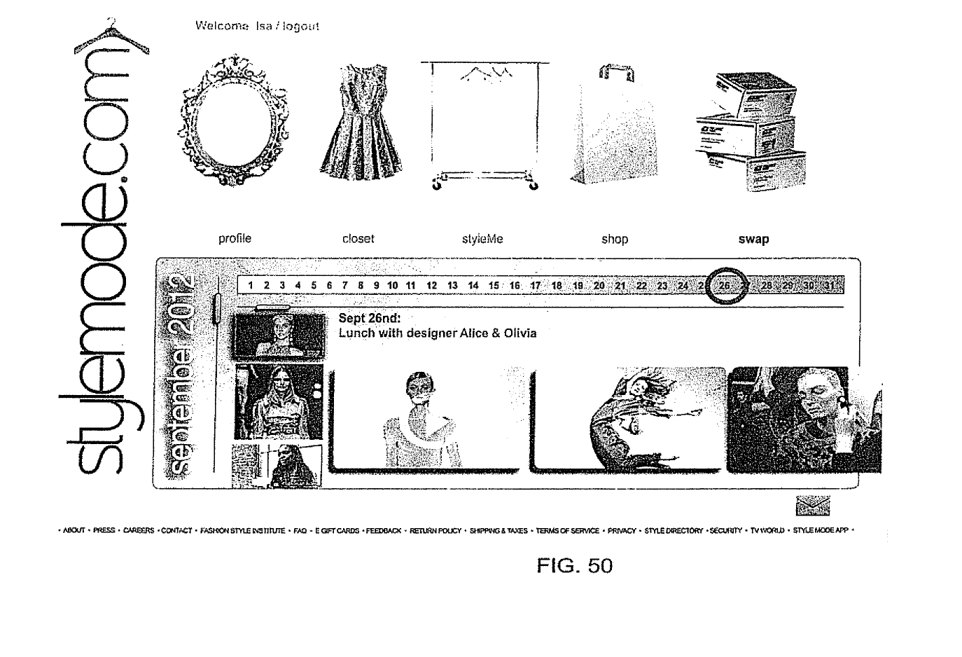

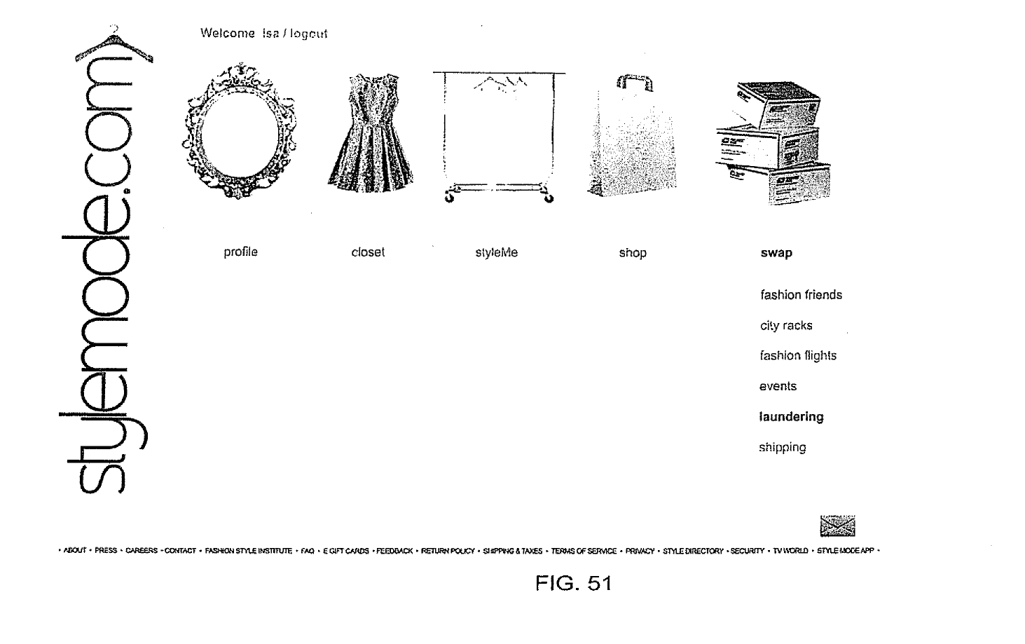

Other functionalities in Swap engine 650 includes a fashion travel booking system 654, fashion event tracking system 656 and a knowledge base 658 for tips about clothes laundering and special handling in shipping. FIG. 48 shows an example user interface for booking travel tickets and hotels for fashion shows and other events, FIGS. 49-50 show an example user interface for tracking fashion events and placing such events on calendar provided by the system. The events may be displayed in the form of video and image. FIGS. 51-56 show examples of user interface that display the knowledge base in multimedia forms, with video streams, images, sounds and music.

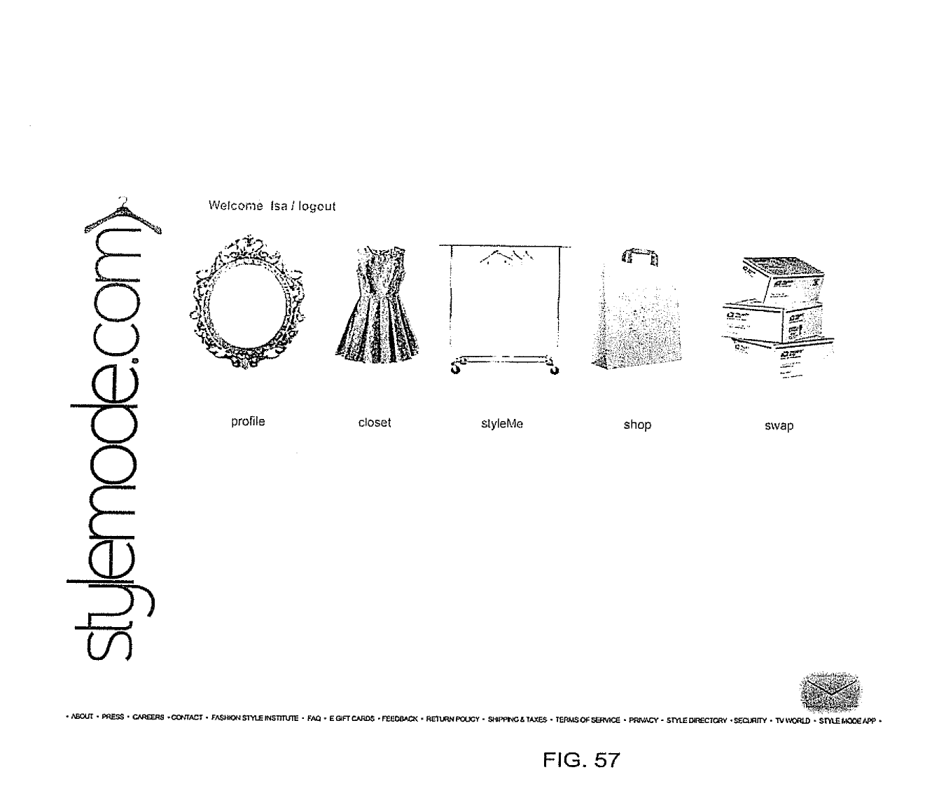

An email or any other type of electronic message process and messaging system 670 is included in StyleMeWorld network system that provides a consistent look and feel for the whole user experience of the system. Email messages of any kind, including *text messages and voicemail messages, fax messages and other kind of messaging system that could be available now or in the future. It is understood, that any type of message or electronic transmission in this disclosure can be of any combination of text, voice mail, data, video, or any combination of other data format now known or later developed and can take a user to an embedded link of a sender's Closet and or a “my styled looks” display or a tradable item for swapping. FIGS. 57-60 show example user interfaces for email sending and receiving and embedded functions. StyleMeWorld mail provides an easy and organized way to keep ongoing or pending StyleMeWorld activities stored and easy to manage, to notify of an activity in the account and it becomes a fashion related email based network.

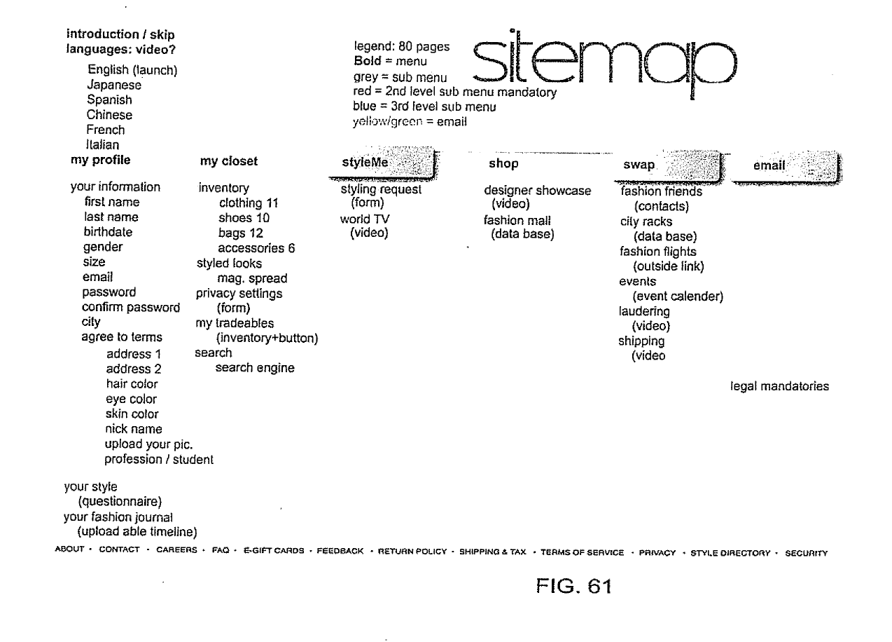

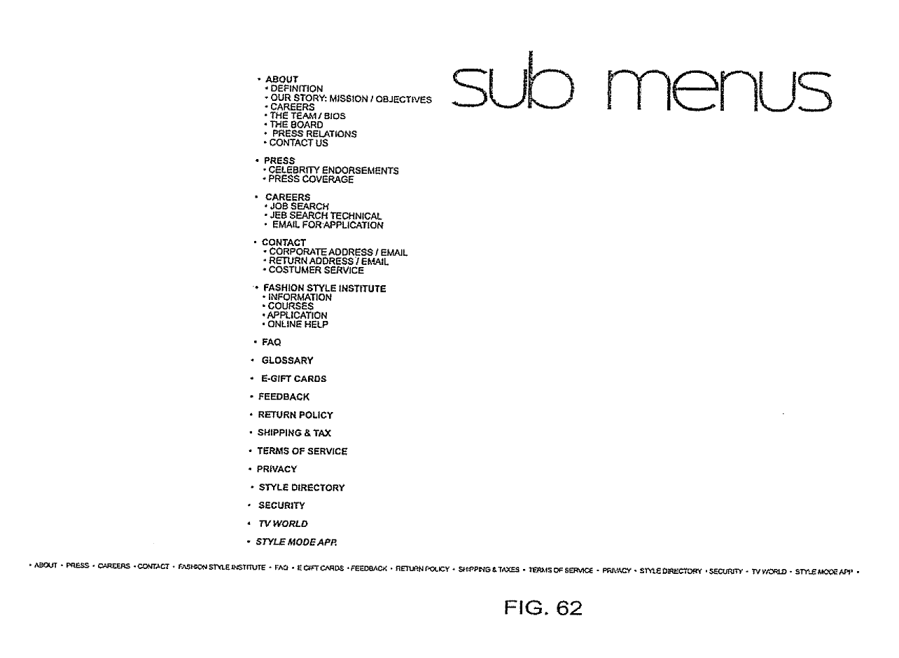

StyleMeWorld network also offers a sitemap page for page index of all the pages, so that a user can access any functionality in the system with just one click. FIGS. 61 and 62 show an example user interface of such sitemap pages.

The system builds a group of end user databases 710 that are linked with end user closet inventory database 712, friend list database 714, transaction databases 716, messaging databases 718 and style journal records database 720.

FIGS. 2B and 2C illustrate the functionalities provided for fashion service providers and for system editors.

Functionality module 300 demonstrates functionalities provided for fashion providers. Fashion providers can login through the login functionality 301, and after successful authorization process through username and password and perhaps a secret image selected by user for authentication, and any other method of login in, credit card, voice, biometric (face, finger, palm, etc). and other methods that could be available in the future for auto recognition. A service provider has access to Registration module 310, Store Builder 320, Business Link 330, Designer showcase upload 340, Email/Messaging system 360, Provider Billing/Accounting management module 380 and Event Tacking Calendar 390. All these functionalities are brokered through a functionality controller 302. The Designer Showcase module 340 uploads multimedia videos as well as web pages of the designer for fashion item display. Video Streaming player 350 allows for YOUTUBE® style video playing without video downloading to an end user's local machine. If other technology is available for faster video viewing experience, StyleMeWorld program may automatically update to such chatting technology. Chatting and messaging module 370 allows a provider to chat live with an end user who is surfing his/her showcase or business link to answer questions.

As shown in FIG. 4, the system builds a group of provider databases 730 that are linked with a group of specific databases serving the service providers, the Store Databases 732, the showcase databases 734, transaction databases 736, and messaging databases 738.

In reference to FIG. 2C, it shows a functional module 400 for system editors and administrators. The functionalities include system editor login module 401, publication collection input module 410, World.TV multimedia input module 420 which is linked with three sub-modules, module 421 for inputting street fashion trends, module 422 for summaries of a city's fashion trends, and module 423 for fashion contents submitted from all over the world. Email/messaging system 430 for providing live chat with users and system services. Billing/accounting module 400 to manage user membership accounts. Module 450 for taking care of other related administrative tasks like gift cards, feedbacks, users comments, press releases, etc.

As shown in FIG. 4, System editors and administrators have the rights to provide content that are available to all users and to manage and editing those contents. The databases specifically built by system editors and administrators are Editor databases 750, Fashion Knowledge databases 752, publication collection databases 756, TV media databases 758. Editors and administrators may also have access rights to management all transactional databases of all users.

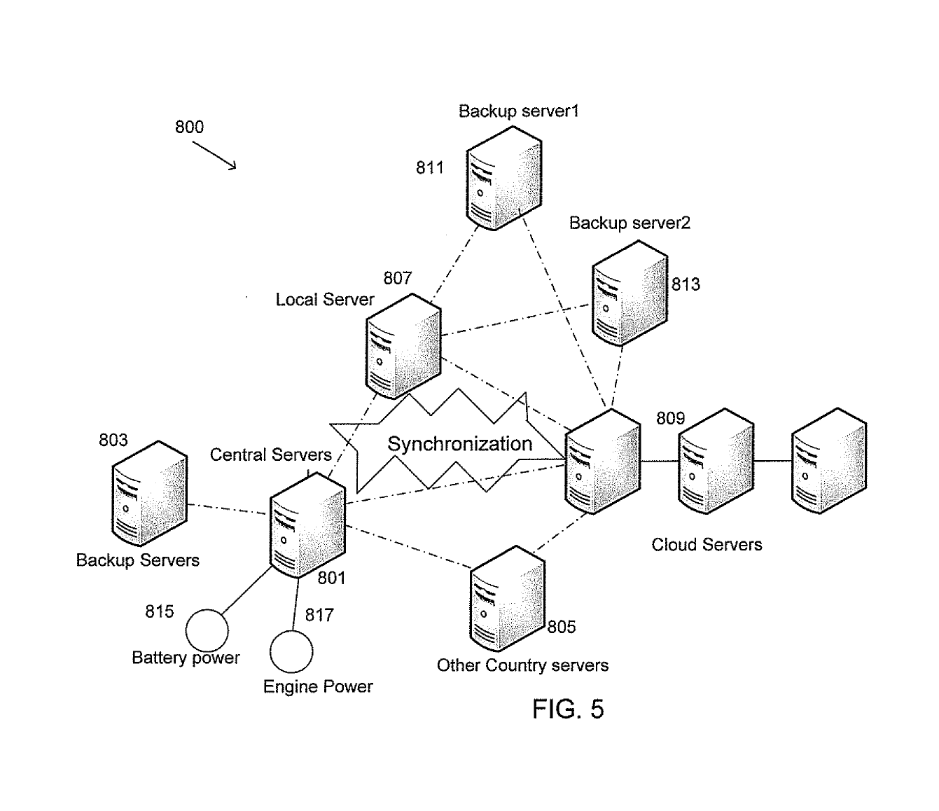

In reference to FIG. 5, the fashion service network includes a comprehensive system and hierarchy of servers, including for example, central servers 801 and their back ups 803, regional local servers 807 and their back up servers 811 and 813. In each different country, at least one central server 805 and its back ups and many regional servers. Preferably for every 100 miles there is a regional server and its back up server providing services to local community as well as providing for service access in responding to requests through central server or central servers by other regions or countries. In addition the fashion service is available through a cloud server system 809, where all end users personal data and collections and their professional service providers' connections are automatically stored and available from anywhere. The data on servers are periodically synchronized between a group of local regional servers and back ups and their central servers and their back ups and between cloud servers and central servers of different countries, and data are distributely stored locally and centrally according to their geographical regions. Each server should be powered with multiple power supplies, with engine power generators and battery power supplies, to guarantee a server 24/7 performance and access of all time. Proper server failure prevention mechanism is built into the system, when one server fails, the service requests and functions are automatically re-delegated to a backup server or a closest regional server. Calling volumes are automatically scaled to other servers or back up servers when a heavy traffic occurs to a particular server.

Communication protocols should include all necessary protocols, for example, the 3G and 4G wireless networks and any other future network and connection that would benefit our users, including http and IP networks, to ensure secure and smooth connections from wireless network to internet networks.

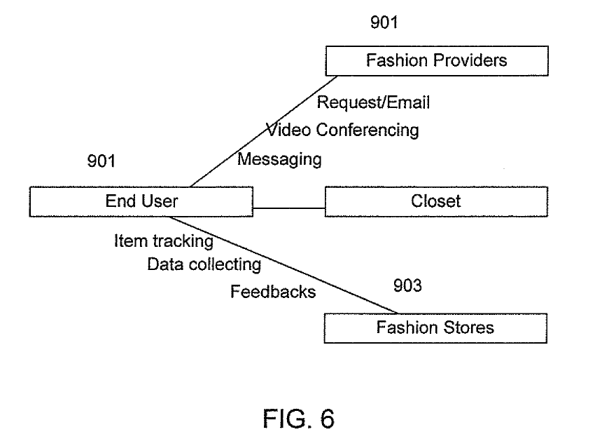

In reference to FIG. 6, multiple channels of communication mechanisms are built into the system to provide full spectrum of tracking and information exchange for end users, store owners and fashion service providers. Items purchased from stores in this system are automatically tracked with bar codes or other tracking mechanisms now known or developed in the future, such as for a non-limiting example the bar code and magnetic strip options which stores information electronically and visually. Information about a particular item purchased by a user, such as item images, the designer, the manufacturer, store names, any online comments, and other users' feedbacks, may be automatically propagated into the user's closet inventory. Registered end users can also schedule video conferences with fashion service providers, and communicate through messaging system and email systems. Communication histories are automatically archived, stored and categorized under subject matters and designer names, and perhaps with a few user specified keywords for later searches.

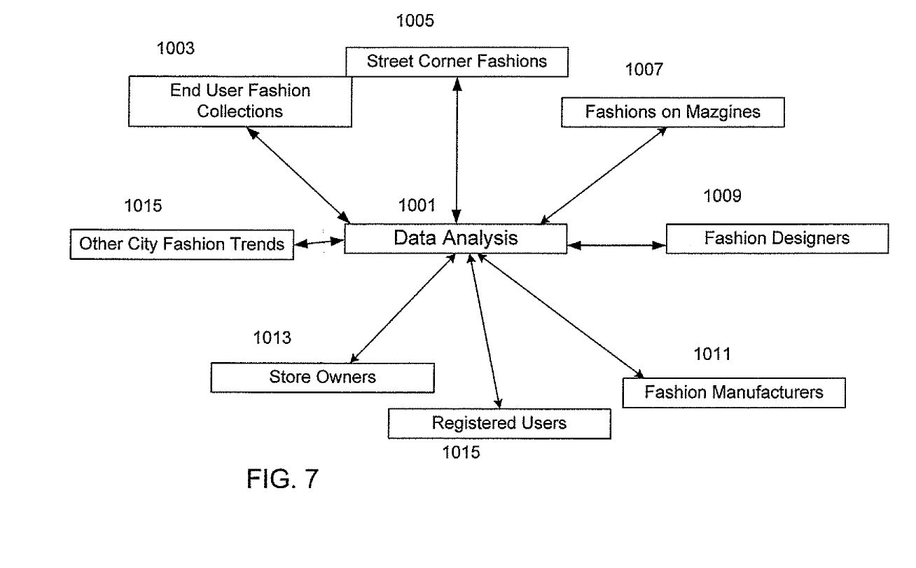

In reference to FIG. 7, a data analysis mechanism 1001 is built into the system for tracking and providing market guidance for end users, store owner and fashion service providers. Various end users closet collections and recent purchases 1003 may be used for general fashion market trend analysis as well as demographic fashion trend analysis among different populations. City fashion trends 1015 monitored through magazines, journals, local newspapers, local fashion shows and social activities are collected to provide short and long term city fashion trends and fashion guides, and to provide a reference fashion trend suggestions for other cities and people of different professions. Street corner fashion reports 1005 from reporters working for the system, from registered end users and online comments are collected for data analysis to further provide guidance for street fashions and casual dressing styles and for providing targeted style improving suggestions. Fashions on magazines and new papers 1007 can be regularly fed into the system and categorized into different fields and databases. Spikes in sales, average money spending trends are analyzed to provide promotional suggestions and marketing strategies for manufacturers and store owners.

These data analyses are accessible for registered users 1015, fashion service providers 1009, store owners 1013. Special data analysis, fashion presentations, fashion design brain storms may be performed on commission basis, such as a historical studies on fashion trends, fashion comparisons among different regions of the world, data collections of fashion shows, most popular styles of the year, most popular dressings among an age group.

Example data analyses for end users may include customer feedbacks on particular items, what other items are purchased in addition to a particular item, what are the associated market promotions, what are the most swapped items, and the most valuable used items. What other fashion combinations or ideas that are posted online for viewing regarding a particular closet item. Any charitable activities currently on going for donations of used items; anyone in need, or in search of a particular item; any recycling activities or commercially available recycle activities.

Example data analyses for fashion service providers may include fashion character analysis from raw street fashion data and publications and end users' collections. Chronic images of a particular fashion item over a period of time or over a particular region or over a particular age or over a particular population, around the world, to provide any flash of genius may be requested and accessed. Market demands and party style information, other fashion service providers' ideas, seminars and shows about a particular item may be displayed in images and in presentations according to styles or names or keyword.

Example data analyses for store owners include market trend projections as to the spread of one fashion from one place to another, the seasonal cycles of a fashion style. Surge of sales in one particular item may predict the surge of an associated item in related areas. Store owners may also conduct various analyses on market leads by surveying what are the most common owned items in the end users' closets and provide suggestions for new uses and new combinations in fashions.

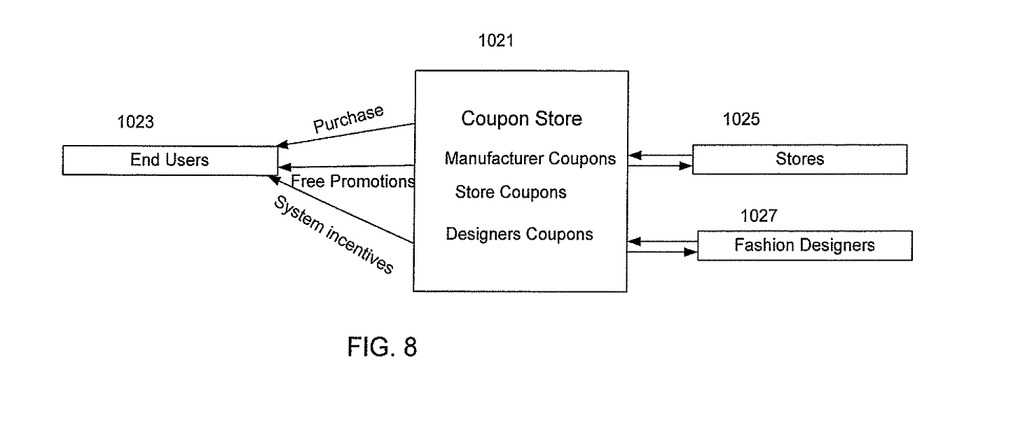

In reference to FIG. 8, a coupon store 1021 is built into the system to provide incentives for users, and a channel for manufacturers to promote products. Coupons or any other method of providing the benefits that a regular coupon provides, available now or in the future in order to bring an advantage of any kind to the system users. Such benefits are not limited by means of coupon but by any method that best delivers these benefits. Users 1023 may be rewarded with coupons upon reaching certain level of spending by manufacturers or by store owners. Users may also be rewarded with coupons for trying certain new fashions and new items. Users may be rewarded with coupons by the system for checking into their closet or for using the system. Further, users can purchase coupons for sales on limited time basis or on items with limited supplies. Users may purchase coupons for famous designer items that are normally not for sale.

Store owners 1025 may either purchase and/or issue coupons through the system. Store owners may be rewarded with coupons from manufacturers and from fashion designers. Store owners may also be rewarded with coupons from the system.

The coupon system automatically records and tracks the usage of coupons for their efficiency and the specificity in using coupons for promotions.

The present invention may be embodied as a system, a method or a computer software program product. Accordingly, the invention may take the form of a hardware embodiment, a software embodiment, or an embodiment combining software and hardware. Furthermore, the present invention may take the form of a computer program product embodied in any tangible medium of expression having computer-usable program code embodied in electronic devices. Specific examples of the computer and electronic devices can include large electronic computing system, personal computing devices, cell phones or personal gadgets, routers, database server machines, hard disks, random access memories, flash memories, portable compact discs, internet connection cables, computer processors, cameras, and any types of networking technologies available now and in the future, that could improve the system.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

None of the description in the present application should be read as implying that any particular element, step, or function is an essential element which must be included in the claim scope. Moreover, none of these claims are intended to invoke paragraph six of 35 USC section 112 unless the exact words “means for” are followed by a participle.

The claims as filed are intended to be as comprehensive as possible, and no subject matter is intentionally relinquished, dedicated, or abandoned.

What is claimed is:

1. An electronic network system for personalized fashion services, comprising:
a closet module that enables a user to build a virtual closet inventory in accordance the user's physical closet inventory, wherein said closet module comprises a virtual fitting room providing a personalized style design for the user based on the virtual closet inventory;
a styling platform wherein said user is enabled to invite a third person to survey said closet inventory;
a shopping platform enabling selecting and purchase based upon a user designation or recommendation of another system user; and
a swapping service engine allowing the user and a friend of the user to swap an item in their virtual closet inventory.

2. The electronic network system of claim 1, wherein said third person is a stylist who is invited by sending a formal request of said network system by the user.

3. The electronic network system of claim 1, wherein said third person is a friend who is invited by sending a message by the user.

4. The electronic network system of claim 1, wherein said styling platform further comprises an editorial window wherein said user is enabled to access a collection of fashion publications selected by an editor of the network system.

5. The electronic network system of claim 1, wherein said styling platform further comprises a multimedia platform wherein said user is enabled to access a collection of fashion related multimedia selected by an another operably linked with the network system.

6. The electronic network system of claim 5, wherein the collection of fashion related multimedia comprises a collection of multimedia about street fashion, a collection of multimedia about a city fashion summary, a collection of multimedia about current fashion reports and a collection of multimedia about fashion trends around the world.

7. The electronic network system of claim 1, further comprising:
a showcase builder that uploads a showcase of a professional service provider into said network system for searching and displaying; and
a store builder that builds a collection of items for a service provider to sell in said network system.

8. The electronic network system of claim 1, further comprising:
a shopping platform wherein a user is enabled to access a showcase by a service provider, and to shop an item via one of an index, a designer index, a category index.

9. The electronic network system of claim 8, wherein said shopping platform further provides a summary of market information. c

10. The electronic network system of claim 1, further comprising
a profile module wherein the user is enabled to indentify fashion favorites and the user is enabled to build a fashion journal recording a personal fashion moment.

11. The electronic network system of claim 1, wherein said closet module, said styling platform and said swapping service engine are located on a plurality of electronic server machines wherein at one server is present for an operably designated distance to effective to result in a physical security for said server machines.

12. The electronic network system of claim 11, wherein said plurality of server machines include a central server, at least one regional server, and at least one central server for one other country.

13. The electronic network system of claim 11, wherein said plurality of server machines include a central server, at least one regional server, and at least one central server for one other country.

14. The electronic network system of claim 11, wherein each of said plurality of server machines has at least one backup server.

15. The electronic network system of claim 11, wherein each of said plurality of server machines is powered with both engine power and battery power.

16. The electronic network system of claim 11, wherein said plurality of server machines are periodically synchronized with each other.

17. The electronic network system of claim 11, wherein said plurality of servers are operably connected with a cloud server for providing services.

18. The electronic network system of claim 1, further comprising:
a tracking module for tracking a item sold from a store wherein the virtual closet inventory can retrieve information about the item from the store automatically using an identifier.

19. The electronic network system of claim 18, wherein said identifier is an identification system involving the storage of a merchandise information content.

20. The electronic network system of claim 1, wherein said styling platform includes a video conferencing module that enables a user to video conference with a third person.

21. The electronic network system of claim 1, further comprising:
a data analysis module for providing market guidance and general insights.

22. The electronic network system of claim 21, wherein said data analysis module surveys a group of registered users' closets for statistic significance of an item.

23. The electronic network system of claim 21, wherein said data analysis module provides simultaneous services for a user, a fashion designer and a store owner.

24. The electronic network system of claim 1, further comprising:
a coupon store for generating coupons and archiving coupons, wherein said coupon includes apparel information.

25. The electronic network system of claim 24, wherein said coupon store tracks a coupon for its usage.

26. A method to provide personalized fashion services, comprising the steps of:
setting up an electronic network system connecting to the internet;
providing in said network system a closet module that enables a user to build a virtual closet inventory in accordance the user's physical closet inventory, wherein said closet module comprises a virtual fitting room providing a personalized style design for the user based on the virtual closet inventory;
providing in said network system a styling platform wherein said user is enabled to invite a third person to survey said closet inventory; and
providing in said network system a swapping service engine allowing the user and a friend of the user to swap an item in their virtual closet inventory.

27. The method of claim 26, wherein said third person is a stylist who is invited by sending a formal request of said network system by the user.

28. The method of claim 26, wherein said third person is a friend who is invited by sending a message by the user.

29. The method of claim 26, wherein said styling platform further comprises an editorial window wherein said user is enabled to access a collection of fashion publications selected by another user of the network system.

30. The method of claim 26, wherein said styling platform further comprises a multimedia platform, wherein said user is enabled to access a collection of fashion related multimedia selected by another user of the network system.

31. The method of claim 30, wherein the collection of fashion related multimedia comprises a collection of multimedia about street fashion, a collection of multimedia about a city fashion summary, a collection of multimedia about current fashion reports and a collection of multimedia about fashion trends around the world.

32. The method of claim 26, further comprising:
providing in said network system a showcase builder that uploads a showcase of a professional service provider into said network system for searching and displaying; and
providing in said network system a store builder that builds a collection of items for a service provider to sell in said network system.

33. The method of claim 26, further comprising:
providing in said network system a shopping platform wherein a user is enabled to access a showcase by a service provider, and to shop an item via either one of an index, a designer index, and a category index.

34. The method of claim 33, wherein said shopping platform further provides a summary of market information.

35. The method of claim 26, further comprising
providing in said network system a profile module wherein the user is enabled to indentify fashion favorites and the user is enabled to build a fashion journal recording a personal fashion moment.

36. The method of claim 26, wherein said closet module, said styling platform and said swapping service engine are located on a plurality of electronic server machines wherein at one server is present at a user-selected distance in a serviced area effective to maximize an operational security of said electronic server machines.

37. The method of claim 36, wherein said plurality of server machines include a central server, at least one regional server, and at least one central server for one other country.

38. The method of claim 36, wherein said plurality of server machines include a central server, at least one regional server, and at least one central server for one other country.

39. The method of claim 36, wherein each of said plurality of server machines has at least one backup server.

40. The method of claim 36, wherein each of said plurality of server machines is powered with both engine power and battery power.

41. The method of claim 36, wherein said plurality of server machines are periodically synchronized with each other.

42. The method of claim 36, wherein said plurality of servers are operably connected with a cloud server for providing services.

43. The method of claim 26, further comprising:
providing in said network system a tracking module for tracking a item sold from a store wherein the virtual closet inventory can retrieve information about the item from the store automatically using an identifier.

44. The method of claim 43, wherein said identifier is an electronically designated system, containing at least one of an alphanumerical, a numeric, and a visual encodation.

45. The method of claim 26, wherein said styling platform includes a video conferencing module that enables a user to video conference with at least one other person.

46. The method of claim 26, further comprising:
providing in said network system a data analysis module for providing market guidance and general insights.

47. The method of claim 46, wherein said data analysis module surveys a group of registered users' closets for statistic significance of an item.

48. The method of claim 46, wherein said data analysis module provides simultaneous services for a user, a fashion designer and a store owner.

49. The method of claim 26, further comprising:
providing in said network system a coupon store for generating coupon instruments and archiving coupon instruments.

50. The method of claim 49, wherein said coupon store tracks a coupon for its usage.

51. The electronic system of claim 1, further comprising:
a module for a fashion mall that the user is enabled to shop by one of a designer name, a category, or another system-defined category.
a module for a designer showcase that a designer is enabled to display information about a brand name;
a module for email fashion-networking; and a module for city racks.
